(19) United States
(12) Patent Application Publication
(10) Pub. No.: US 2026/0183793 A1
(43) Pub. Date: Jul. 2, 2026

(54) VIBRATION APPARATUS AND APPARATUS COMPRISING THE SAME

(71) Applicant: LG Display Co., Ltd., Seoul (KR)

(72) Inventor: Yong-Su HAM, Paju-si (KR)

(73) Assignee: LG Display Co., Ltd., Seoul (KR)

(21) Appl. No.: 19/347,003

(22) Filed: Oct. 1, 2025

(30) Foreign Application Priority Data
Dec. 27, 2024 (KR) 10-2024-0198330

(51) Int. Cl. B06B 1/06

(52) U.S. Cl. CPC B06B 1/0648

(57) ABSTRACT

A vibration apparatus includes a vibration generating part including a plurality of vibration portions, a connection layer between the plurality of vibration portions, and a signal cable electrically connected to the plurality of vibration portions. Each of the plurality of vibration portions includes at least one or more connection portions, and the signal cable is non-overlapping with the at least one or more connection portions.

### CROSS-REFERENCE TO RELATED APPLICATION

This application claims the benefit of and priority to Korean Patent Application No. 10-2024-0198330 filed on Dec. 27, 2024, the entire contents of which are incorporated herein by reference for all purposes as if fully set forth herein.

### BACKGROUND

### 1. Technical Field

The present disclosure relates to a vibration apparatus and apparatus comprising the same.

### 2. Description of Related Art

Recently, demand for slimming and thinning of electronic devices is increasing. In accordance with the demand for slimming and thinning, a piezoelectric device method that can be implemented in a thin thickness instead of a voice coil method is attracting attention.

A speaker or vibration apparatus to which a piezoelectric device is applied may be driven or vibrated by receiving driving power or driving signals from a signal cable.

The description of related art should not be considered prior art merely because it is mentioned in or associated with this section. The description of related art includes information that describes one or more aspects of the subject technology, and the description in this section does not limit the scope of the invention.

### SUMMARY

The inventors of the present disclosure have conducted various studies and experiments to implement a vibration apparatus that may simplify the structure and manufacturing process of the vibration apparatus. Through various studies and experiments, a vibration apparatus having a new structure capable of simplifying the structure and manufacturing process of the vibration apparatus and an apparatus comprising the same have been invented.

One or more aspects of the present disclosure are directed to provide a vibration apparatus capable of simplifying a structure and a manufacturing process, and an apparatus comprising the same.

One or more aspects of the present disclosure are directed to provide a vibration apparatus capable of preventing the occurrence of cracks in a vibration apparatus, and an apparatus comprising the same.

One or more aspects of the present disclosure are directed to provide a vibration apparatus capable of reducing weight and thickness, and an apparatus comprising the same.

One or more aspects of the present disclosure are directed to provide a vibration apparatus capable of improving sound pressure characteristics of sound, and an apparatus comprising the same.

Additional features, advantages, and aspects of the present disclosure are set forth in part in the present disclosure and will also be apparent from the present disclosure or may be learned by practice of the inventive concepts provided herein. Other features, advantages, and aspects of the present disclosure may be realized and attained by the descriptions provided in the present disclosure, or derivable therefrom, and claims hereof as well as the appended drawings.

To achieve these and other advantages and aspects of the present disclosure, as embodied and broadly described herein, in one or more aspects, a vibration apparatus may comprise a vibration generating part including a plurality of vibration portions, a connection layer between the plurality of vibration portions, and a signal cable electrically connected to the plurality of vibration portions. Each of the plurality of vibration portions may include at least one or more connection portions, and the signal cable may be non-overlapping with the at least one or more connection portions.

In one or more aspects, an apparatus may comprise a passive vibration member, and a vibration generating apparatus connected to the passive vibration member and vibrating the passive vibration member. The vibration generating apparatus may include a vibration apparatus. The vibration apparatus may comprise a vibration generating part including a plurality of vibration portions, a connection layer between the plurality of vibration portions, and a signal cable electrically connected to the plurality of vibration portions. Each of the plurality of vibration portions may include at least one or more connection portions, and the signal cable may be non-overlapping with the at least one or more connection portions.

Details of other example embodiments will be included in the detailed description of the disclosure and the accompanying drawings.

According to one or more embodiments of the present disclosure, the vibration apparatus and the apparatus comprising the same may simplify the structure and manufacturing process.

According to one or more embodiments of the present disclosure, by reducing the thickness and weight of the vibration apparatus, a lightweight vibration apparatus may be implemented.

According to one or more embodiments of the present disclosure, since the yield may be improved by preventing defects such as cracks occurring in the vibration apparatus, process optimization may be implemented through reduction of production energy.

According to one or more embodiments of the present disclosure, by simplifying the manufacturing process, production energy reduction and process optimization can be implemented.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 is a diagram illustrating a vibration apparatus according to an embodiment of the present disclosure.

FIG. 2 is an exploded perspective view illustrating a connection structure between a signal cable and a vibration generating part shown in FIG. 1 according to an embodiment of the present disclosure.

FIG. 3 is a cross-sectional view taken along the line A-A′ shown in FIG. 1.

FIG. 4 is a cross-sectional view taken along line B-B′ shown in FIG. 1.

FIG. 5 is a cross-sectional view taken along the line C-C′ shown in FIG. 1.

FIG. 6 is a cross-sectional view taken along the line D-D′ shown in FIG. 1.

FIG. 7 is a cross-sectional view taken along the line E-E′ shown in FIG. 1.

FIG. 8 is a cross-sectional view taken along the line F-F′ shown in FIG. 1.

FIG. 9 is a diagram illustrating a vibration apparatus according to another embodiment of the present disclosure.

FIG. 10 is a cross-sectional view taken along the line G-G′ shown in FIG. 9.

FIG. 11 is a cross-sectional view taken along the line H-H′ shown in FIG. 9.

FIG. 12 is a cross-sectional view taken along the line I-I′ shown in FIG. 9.

FIG. 13 is a cross-sectional view taken along a line J-J′ shown in FIG. 9.

FIG. 14 is a diagram illustrating an apparatus according to an embodiment of the present disclosure.

FIG. 15 is a cross-sectional view taken along a line K-K′ illustrated in FIG. 14.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and convenience.

### DETAILED DESCRIPTION

Advantages and features of the present disclosure, and implementation methods thereof will be clarified through following embodiments described with reference to the accompanying drawings. The present disclosure can, however, be embodied in different forms and should not be construed as limited to the embodiments set forth herein. Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted.

In a case where “comprise,” “have,” and “include” described in the present disclosure are used, another part can be added unless “only” or the like is used. The terms in a singular form may include plural forms unless noted to the contrary. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise.

In construing an element, the element is construed as including an error or tolerance range although there is no explicit description of such an error or tolerance range.

In describing a position relationship, for example, when a position relation between two parts is described as, for example, “on,” “over,” “under,” and “next,” one or more other parts can be disposed between the two parts unless a more limiting term, such as “just” or “direct(ly)” is used.

In describing a time relationship, for example, when the temporal order is described as, for example, “after,” “subsequent,” “next,” and “before,” a case that is not continuous can be included unless a more limiting term, such as “just,” “immediate(ly),” or “direct(ly)” is used.

It will be understood that, although the terms “first,” “second,” and the like can be used herein to describe various elements, these elements should not be limited by these terms. These terms are only used to distinguish one element from another and may not define any order. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element (e.g., layer, film, region, component, section, or the like) is described as “connected,” “coupled,” “attached,” “adhered,” or the like to another element, the element can not only be directly connected, coupled, attached, adhered, or the like to another element, but also be indirectly connected, coupled, attached, adhered, or the like to another element with one or more intervening elements disposed or interposed between the elements, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item. Also, the term “can” used herein includes all meanings and definitions of the word “may.”

Features of various embodiments of the present disclosure can be partially or overall coupled to or combined with each other, and can be variously inter-operated with each other and driven technically as those skilled in the art can sufficiently understand. The embodiments of the present disclosure can be carried out independently from each other, or can be carried out together in co-dependent relationship.

Hereinafter, embodiments of the present disclosure will be described in detail with reference to the accompanying drawings. For convenience of description, a scale of each of elements shown in the accompanying drawings differs from a real scale, and thus, is not limited to a scale shown in the drawings.

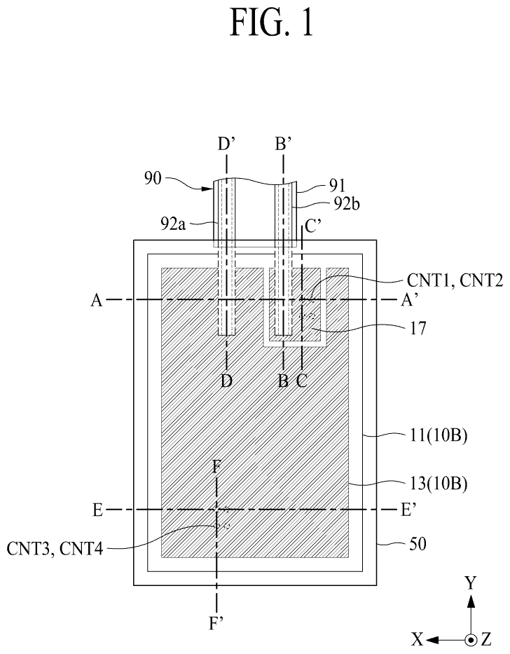

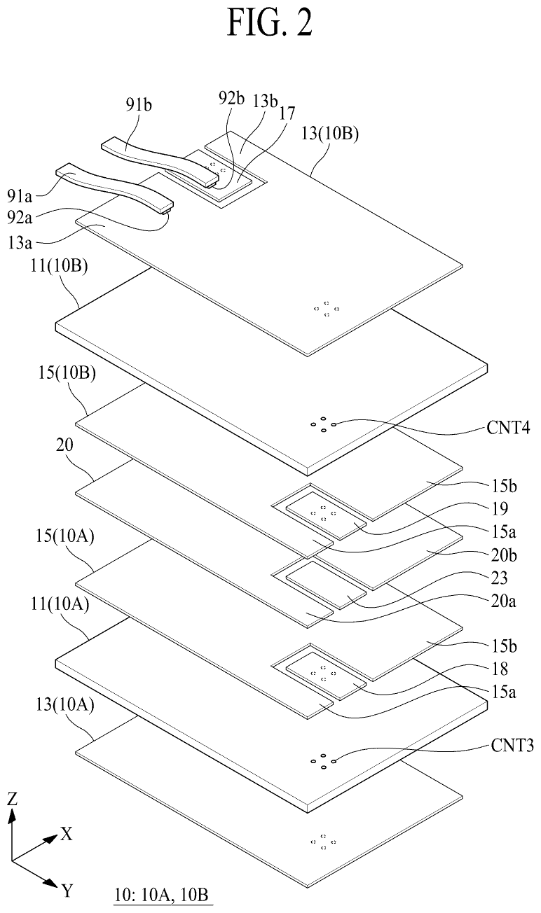

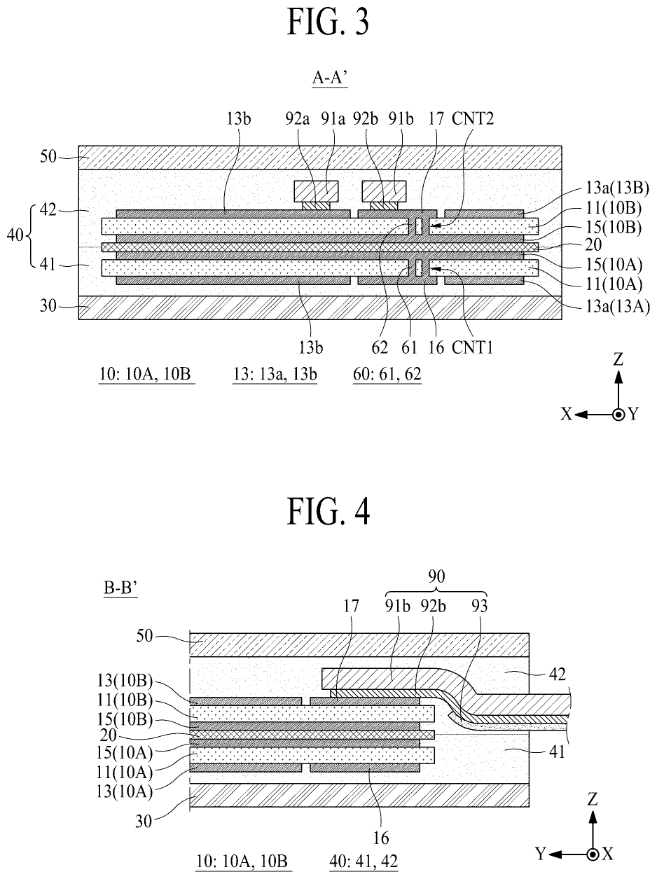

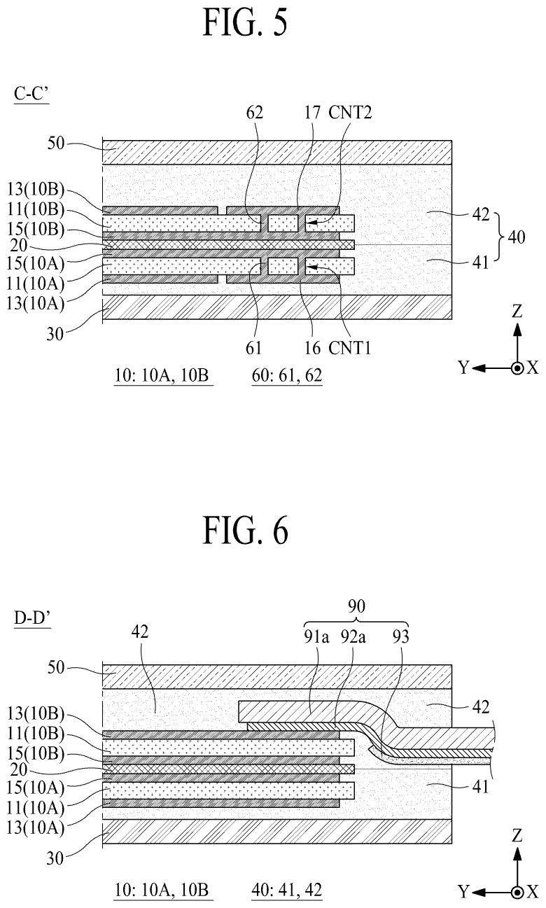

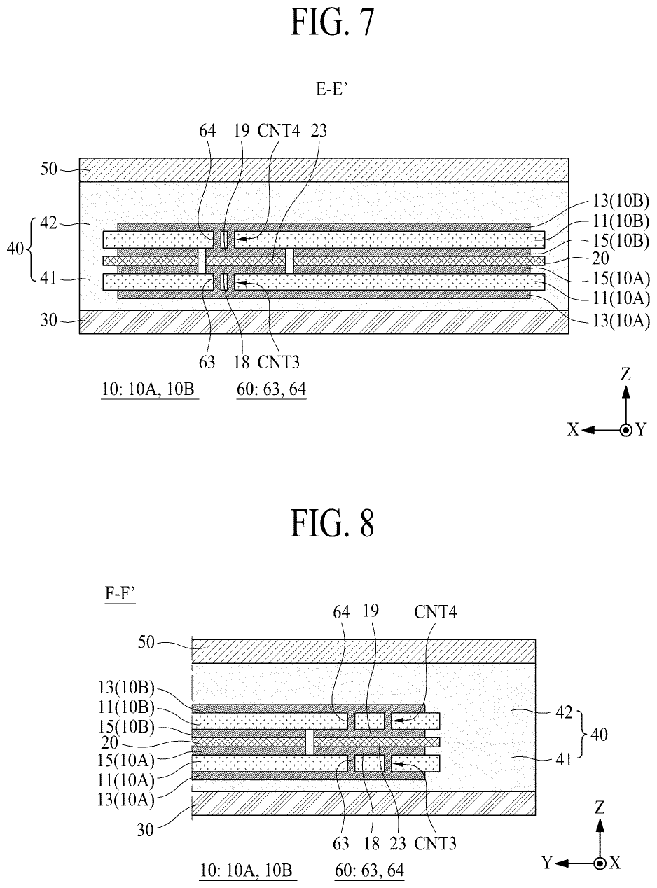

FIG. 1 is a diagram illustrating a vibration apparatus according to an embodiment of the present disclosure. FIG. 2 is an exploded perspective view illustrating a connection structure between a signal cable and a vibration generating part shown in FIG. 1 according to an embodiment of the present disclosure. FIG. 3 is a cross-sectional view taken along the line A-A′ shown in FIG. 1. FIG. 4 is a cross-sectional view taken along line B-B′ shown in FIG. 1. FIG. 5 is a cross-sectional view taken along the line C-C′ shown in FIG. 1. FIG. 6 is a cross-sectional view taken along the line D-D′ shown in FIG. 1. FIG. 7 is a cross-sectional view taken along the line E-E′ shown in FIG. 1. FIG. 8 is a cross-sectional view taken along the line F-F′ shown in FIG. 1.

Referring to FIGS. 1 to 8, a vibration apparatus (200 in FIG. 15) according to an embodiment of the present disclosure may include a vibration generating part 10, a connection layer 20, a connection portion 60, and a signal cable 90.

The vibration generating part 10 may include a plurality of vibration portions 10A and 10B. For example, the vibration generating part 10 may include a plurality of vibration portions 10A and 10B that overlap each other. For example, the vibration generating part 10 may include a plurality of vibration portions 10A and 10B that are vertically stacked or overlapped. For example, the vibration generating part 10 may include a first vibration portion 10A and a second vibration portion 10B stacked on the first vibration portion 10A.

According to an embodiment of the present disclosure, each of the first vibration portion 10A and the second vibration portion 10B may include a piezoelectric material (or an electroactive material) including a piezoelectric effect or a piezoelectric device. For example, piezoelectric materials (or piezoelectric devices) may have characteristics in which pressure or torsion acts on the crystal structure of the piezoelectric material by an external force, causing a potential difference due to dielectric polarization due to changes in the relative positions of positive (+) and negative (−) ions, and vibration is generated by an electric field according to the applied voltage.

Each of the first vibration portion 10A and the second vibration portion 10B may include a vibration layer 11, a first electrode layer 13, and a second electrode layer 15.

The vibration layer 11 may include a piezoelectric material (or an electroactive material) including a piezoelectric effect. The vibration layer 11 may be formed of a ceramic-based material capable of realizing relatively high vibration or may be formed of a piezoelectric ceramic having a perovskite-based crystal structure.

The piezoelectric ceramic may be a single crystal ceramic having a single crystal structure, or may be a ceramic material having a polycrystalline structure or a polycrystalline ceramic. The piezoelectric material of the single crystal ceramic may include α-AlPO₄, α-SiO₂, LiNbO₃, Tb₂(MoO₄)₃, Li₂B₄O₇, or ZnO, but embodiments of the present disclosure are not limited thereto. The piezoelectric material of the polycrystalline ceramic may include a lead zirconate titanium (PZT)-based material including lead (Pb), zirconium (Zr), nickel (Ni), and niobium (Nb), but embodiments of the present disclosure are not limited thereto. In another example, the vibration layer 11 may include at least one of CaTiO₃, BaTiO₃, and SrTiO₃, which do not include lead (Pb), but embodiments of the present disclosure are not limited thereto.

According to embodiments of the present disclosure, the vibration layer 11 of each of the first vibration portion 10A and the second vibration portion 10B may have the same ceramic crystal structure or different ceramic crystal structures. For example, each of the vibration layer 11 of the first vibration portion 10A and the vibration layer 11 of the second vibration portion 10B may be formed of a single crystal ceramic or a polycrystalline ceramic. For example, any one of the vibration layer 11 of the first vibration portion 10A and the vibration layer 11 of the second vibration portion 10B may be formed of a single crystal ceramic, and the other may be formed of a polycrystalline ceramic.

According to an embodiment of the present disclosure, in each of the first vibration portion 10A and the second vibration portion 10B, the vibration layer 11 may be configured (or disposed) between the first electrode layer 13 and the second electrode layer 15.

Referring to FIGS. 2 to 8, in the first vibration portion 10A, the first electrode layer 13 may be disposed on the first surface (or the lower surface) of the vibration layer 11. The first electrode layer 13 may have the same size as the vibration layer 11 or may have a smaller size than the vibration layer 11, but embodiments of the present disclosure are not limited thereto. For example, the first electrode layer 13 may include a single electrode shape. For example, the first electrode layer 13 may have a rectangular shape. For example, an end (or a side surface) of the first electrode layer 13 may be spaced apart from an end (or a side surface) of the vibration layer 11, thereby preventing an electrical connection (or short circuit) between the first electrode layer 13 and the second electrode layer 15. For example, the first electrode layer 13 of the first vibration portion 10A may be the first electrode layer, the lower electrode layer, or the lowermost electrode layer of the vibration generating part 10, but embodiments of the present disclosure are not limited thereto.

In the first vibration portion 10A, the second electrode layer 15 may be disposed on a second surface (or an upper surface) that is different from or opposite to the first surface of the vibration layer 11. The second electrode layer 15 may have a size smaller than that of the vibration layer 11, but embodiments of the present disclosure are not limited thereto. For example, the second electrode layer 15 of the first vibration portion 10A may be the second electrode layer of the vibration generating part 10, but embodiments of the present disclosure are not limited thereto.

As an embodiment of the present disclosure, in the first vibration portion 10A, the first electrode layer 13 may include a plurality of protrusion portions 13a and 13b protruding (or extending) from one end (or one side). A plurality of protrusion portions 13a and 13b may be spaced apart from each other and arranged in parallel. Accordingly, the first electrode layer 13 may not be formed in a region where a plurality of protrusion portions 13a and 13b are spaced apart from each other, and the first surface (or the lower surface) of the vibration layer 11 may be exposed. As shown in FIG. 3, the shape of the first electrode layer 13 of the first vibration portion 10A is the same as the shape of the first electrode layer 13 of the second vibration portion 10B. The positions and shapes of a plurality of protrusion portions 13a and 13b of the first vibration portion 10A may be the same as those of a plurality of protrusion portions 13a and 13b of the second vibration portion 10B. Therefore, the positions and shapes of a plurality of protrusion portions 13a and 13b of the first vibration portion 10A may refer to the second vibration portion 10B.

As another embodiment of the present disclosure, in the first vibration portion 10A, the first electrode layer 13 may include a concave portion concave from a portion of one end (or one side). The concave portion may be formed to be concave in the second direction Y from the central portion of one end (or one side) of the first electrode layer 13. For example, the concave portion may be formed to have constant length in the second direction Y from the central portion of one end (or one side) of the first electrode layer 13. For example, the concave portion may be formed between a plurality of protrusion portions (or a pair of protrusion portions) 13a and 13b, but embodiments of the present disclosure are not limited thereto. For example, the concave portion may be a portion from which a portion of the first electrode layer 13 is removed, or a portion where the first electrode layer 13 is not formed. For example, the concave portion may be a patterning portion, an electrode non-forming portion, an electrode non-disposing portion, or an open portion, but embodiments of the present disclosure are not limited thereto.

As an embodiment of the present disclosure, in the first vibration portion 10A, the second electrode layer 15 may include a plurality of protrusion portions 15a and 15b protruding (or extending) from the other end (or the other side). A plurality of protrusion portions 15a and 15b may be spaced apart from each other and disposed in parallel. Accordingly, the second electrode layer 15 may not be formed in a region where a plurality of protrusion portions 15a and 15b are spaced apart from each other, and the second surface (or the upper surface) of the vibration layer 11 may be exposed.

As another embodiment of the present disclosure, in the first vibration portion 10A, the second electrode layer 15 may include a concave portion concave from a portion of the other end (or the other side). The concave portion may be formed to be concave in the second direction Y from a central portion of one end (or one side) of the second electrode layer 15. For example, the concave portion may be formed to have a constant length in the second direction Y from a central portion of one end (or one side) of the second electrode layer 15. For example, the concave portion may be formed between a plurality of protrusion portions (or a pair of protrusion portions) 15a and 15b, but embodiments of the present disclosure are not limited thereto. For example, the concave portion may be a portion from which a portion of the second electrode layer 15 is removed, or a portion in which the second electrode layer 15 is not formed. For example, the concave portion may be a patterning portion, an electrode non-forming portion, an electrode non-disposing portion, or an open portion, but embodiments of the present disclosure are not limited thereto.

According to an embodiment of the present disclosure, the second electrode layer 15 of the first vibration portion 10A and the first electrode layer 13 of the first vibration portion 10A may have different shapes. For example, a plurality of protrusion portions 15a and 15b formed in the second electrode layer 15 of the first vibration portion 10A and a plurality of protrusion portions 13a and 13b formed in the first electrode layer 13 of the first vibration portion 10A may have non-overlapping regions. For example, the concave portion formed in the second electrode layer 15 of the first vibration portion 10A and the concave portion formed in the first electrode layer 13 of the first vibration portion 10A may not overlap each other. For example, the concave portion formed in the second electrode layer 15 of the first vibration portion 10A and the concave portion formed in the first electrode layer 13 of the first vibration portion 10A may be configured not to face each other, but embodiments of the present disclosure are not limited thereto.

In the second vibration portion 10B, the first electrode layer 13 may be disposed on a second surface (or an upper surface) that is different from or opposite to the first surface of the vibration layer 11. The first electrode layer 13 may have a size smaller than that of the vibration layer 11, but embodiments of the present disclosure are not limited thereto. For example, the first electrode layer 13 of the second vibration portion 10B may be the third electrode layer, the upper electrode layer, or the uppermost electrode layer of the vibration generating part 10, but embodiments of the present disclosure are not limited thereto.

As an embodiment of the present disclosure, in the second vibration portion 10B, the first electrode layer 13 may include a plurality of protrusion portions 13a and 13b protruding (or extending) from one end (or one side). A plurality of protrusion portions 13a and 13b may be spaced apart from each other and arranged in parallel. Accordingly, the first electrode layer 13 may not be formed in a region where a plurality of protrusion portions 13a and 13b are spaced apart from each other, and the second surface (or the upper surface) of the vibration layer 11 may be exposed.

As another embodiment of the present disclosure, in the second vibration portion 10B, the first electrode layer 13 may include a concave portion concave from a portion of one end (or one side). The concave portion may be formed to be concave in the second direction Y from the central portion of one end (or one side) of the first electrode layer 13. For example, the concave portion may be formed to have a constant length in the second direction Y from the central portion of one end (or one side) of the first electrode layer 13. For example, the concave portion may be formed between a plurality of protrusion portions (or a pair of protrusion portions) 13a and 13b, but embodiments of the present disclosure are not limited thereto. For example, the concave portion may be a portion from which a portion of the first electrode layer 13 is removed, or a portion where the first electrode layer 13 is not formed. For example, the concave portion may be a patterning portion, an electrode non-forming portion, an electrode non-disposing portion, or an open portion, but embodiments of the present disclosure are not limited thereto.

In the second vibration portion 10B, the second electrode layer 15 may be disposed on a first surface (or a lower surface) that is different from or opposite to the second surface of the vibration layer 11. The second electrode layer 15 may have a size smaller than that of the vibration layer 11, but embodiments of the present disclosure are not limited thereto. For example, the second electrode layer 15 of the second vibration portion 10B may be the fourth electrode layer of the vibration generating part 10, but embodiments of the present disclosure are not limited thereto.

As an embodiment of the present disclosure, in the second vibration portion 10B, the second electrode layer 15 may include a plurality of protrusion portions 15a and 15b protruding (or extending) from one end (or one side). A plurality of protrusion portions 15a and 15b may be spaced apart from each other and disposed in parallel. Accordingly, the second electrode layer 15 may not be formed in a region where a plurality of protrusion portions 15a and 15b are spaced apart from each other, and the first surface (or the lower surface) of the vibration layer 11 may be exposed.

As another embodiment of the present disclosure, in the second vibration portion 10B, the second electrode layer 15 may include a concave portion concave from a portion of one end (or one side). The concave portion may be formed to be concave in the second direction Y from a central portion of one end (or one side) of the second electrode layer 15. For example, the concave portion may be formed to have a constant length in the second direction Y from a central portion of one end (or one side) of the second electrode layer 15. For example, the concave portion may be formed between a plurality of protrusion portions (or a pair of protrusion portions) 15a and 15b, but embodiments of the present disclosure are not limited thereto. For example, the concave portion may be a portion from which a portion of the second electrode layer 15 is removed, or a portion where the second electrode layer 15 is not formed. For example, the concave portion may be a patterning portion, an electrode non-forming portion, an electrode non-disposing portion, or an open portion, but protrusion portion.

According to an embodiment of the present disclosure, the second electrode layer 15 of the second vibration portion 10B and the first electrode layer 13 of the second vibration portion 10B may have different shapes. For example, a plurality of protrusion portions 15a and 15b configured in the second electrode layer 15 of the second vibration portion 10B and a plurality of protrusion portions 13a and 13b configured in the first electrode layer 13 of the second vibration portion 10B may have non-overlapping regions. For example, the concave portion configured in the second electrode layer 15 of the second vibration portion 10B and the concave portion configured in the first electrode layer 13 of the second vibration portion 10B may be non-overlapping. For example, the concave portion configured in the second electrode layer 15 of the second vibration portion 10B and the concave portion configured in the first electrode layer 13 of the second vibration portion 10B may be configured not to face each other, but embodiments of the present disclosure are not limited thereto.

According to an embodiment of the present disclosure, a plurality of protrusion portions 13a and 13b formed in the first electrode layer 13 of the first vibration portion 10A and a plurality of protrusion portions 13a and 13b formed in the first electrode layer 13 of the second vibration portion 10B may overlap each other. For example, the concave portion formed in the first electrode layer 13 of the first vibration portion 10A and the concave portion formed in the first electrode layer 13 of the second vibration portion 10B may overlap.

According to an embodiment of the present disclosure, a plurality of protrusion portions 15a and 15b formed in the second electrode layer 15 of the first vibration portion 10A and a plurality of protrusion portions 15a and 15b formed in the second electrode layer 15 of the second vibration portion 10B may overlap each other. For example, the concave portion formed in the second electrode layer 15 of the first vibration portion 10A and the concave portion formed in the second electrode layer 15 of the second vibration portion 10B may overlap each other.

According to an embodiment of the present disclosure, the second electrode layer 15 of the first vibration portion 10A and the second electrode layer 15 of the second vibration portion 10B may be disposed adjacent to each other. The second electrode layer 15 of the first vibration portion 10A and the second electrode layer 15 of the second vibration portion 10B are disposed adjacent to each other, so that a polarization direction (or a polling direction) formed in the vibration layer 11 of the first vibration portion 10A and a polarization direction (or a polling direction) formed in the vibration layer 11 of the second vibration portion 10B may be configured in a different direction or an opposite direction. For example, the polarization direction formed on each of the vibration layers 11 of the first vibration portion 10A and the second vibration portion 10A may be configured to be directed from the first electrode layer 13 to the second electrode layer 15.

In the stacked structure of the first and second vibration portions 10A and 10B, to prevent an electrical short between vertically adjacent electrode layers, each of the first electrode layer 13 and the second electrode layer 15 may be formed on the remaining portions except for an edge portion (or a periphery portion) of the vibration layer 11. For example, a distance between a side surface of each of the first electrode layer 13 and the second electrode layer 15 and a side surface of the vibration layer 11 may be at least 0.5 mm or more, and embodiments of the present disclosure are not limited thereto. For example, a distance between a side surface of each of the first electrode layer 13 and the second electrode layer 15 and a side surface of the vibration layer 11 may be at least 1 mm or more, but embodiments of the present disclosure are not limited thereto.

According to an embodiment of the present disclosure, at least one of the first electrode layer 13 and the second electrode layer 15 may include a material sintered at a high temperature (for example, 650° C. or less). For example, at least one of the first electrode layer 13 and the second electrode layer 15 may be formed of a transparent conductive material, a translucent conductive material, or an opaque conductive material, but embodiments of the present disclosure are not limited thereto. For example, the transparent or translucent conductive material may include indium tin oxide (ITO) or indium zinc oxide (IZO), but embodiments of the present disclosure are not limited thereto. The opaque conductive material may include gold (Au), silver (Ag), platinum (Pt), palladium (Pd), molybdenum (Mo), magnesium (Mg), carbon, or silver (Ag) containing glass frit or an alloy thereof, but embodiments of the present disclosure are not limited thereto. For example, carbon may be a carbon material including carbon black, ketjen black, carbon nanotubes, and graphite, but embodiments of the present disclosure are not limited thereto.

According to an embodiment of the present disclosure, each of the first electrode layer 13 and the second electrode layer 15 may include silver (Ag) having a low resistivity to improve the electrical and/or vibration characteristics of the vibration layer 11.

In the first electrode layer 13 and the second electrode layer 15 formed of silver (Ag) containing a glass frit, the content of the glass frit may be 1 wt % or more and 12 wt % or less, but embodiments of the present disclosure are not limited thereto. The glass frit may include a PbO or Bi₂O₃-based material, but embodiments of the present disclosure are not limited thereto. For example, the glass frit may include any one of Bi, Zn, Al, B, and Si oxide, but embodiments of the present disclosure are not limited thereto.

The vibration generating part 10 according to an embodiment of the present disclosure may include a plurality of auxiliary electrode layers 16, 17, 18, and 19. A plurality of auxiliary electrode layers may include first to fourth auxiliary electrode layers 16, 17, 18, and 19. The first vibration portion 10A may include first and third auxiliary electrode layers 16 and 18. The second vibration portion 10B may include second and fourth auxiliary electrode layers 17 and 19.

Referring to FIGS. 2 to 6, in the first vibration portion 10A, the first auxiliary electrode layer 16 may be configured (or formed) under the vibration layer 11 to be electrically separated from the first electrode layer 13. The first auxiliary electrode layer 16 may be configured (or formed) on the first surface (or lower surface) of the vibration layer 11 to be electrically separated from the first electrode layer 13. For example, the first auxiliary electrode layer 16 may be configured (or formed) under the vibration layer 11 between a plurality of protrusion portions 13a and 13b in the first electrode layer 13.

In the first vibration portion 10A, the first auxiliary electrode layer 16 may be electrically connected to the second electrode layer 15 through the vibration layer 11. For example, the first auxiliary electrode layer 16 may be electrically connected to the second electrode layer 15 through a first contact hole CNT1 configured (or formed) in the vibration layer 11. For example, in the first vibration portion 10A, a first contact hole CNT1 overlapping the first auxiliary electrode layer 16 may be configured at one end (or one side) of the vibration layer 11. The first contact hole CNT1 may overlap the second electrode layer 15 and the first auxiliary electrode layer 16. The first connection portion 61 of a plurality of connection portions 60 may be inserted into the first contact hole CNT1. The first auxiliary electrode layer 16 and the second electrode layer 15 may be electrically connected through a first contact hole CNT1. The first auxiliary electrode layer 16 may be electrically connected to the second electrode layer 15 of the first vibration portion 10A through the first connection portion 61.

Referring to FIGS. 2, 7, and 8, in the first vibration portion 10A, the third auxiliary electrode layer 18 may be configured (or formed) on the vibration layer 11 to be electrically separated from the second electrode layer 15. The third auxiliary electrode layer 18 may be configured (or formed) on the second surface of the vibration layer 11 to be electrically separated from the second electrode layer 15. For example, the third auxiliary electrode layer 18 may be configured (or formed) on the vibration layer 11 between a plurality of protrusions 15a and 15b in the second electrode layer 15.

In the first vibration portion 10A, the third auxiliary electrode layer 18 may be electrically connected to the first electrode layer 13 through the vibration layer 11. For example, the third auxiliary electrode layer 18 may be electrically connected to the first electrode layer 13 through a third contact hole CNT3 formed (or formed) in the vibration layer 11. For example, in the first vibration portion 10A, the third contact hole CNT3 overlapping the third auxiliary electrode layer 18 may be configured in the other end (or the other side) of the vibration layer 11. The third contact hole CNT3 may overlap the first electrode layer 13 and the third auxiliary electrode layer 18. A third connection portion 63 among a plurality of connection portions 60 may be inserted into the third contact hole CNT3. The third auxiliary electrode layer 18 and the first electrode layer 13 may be electrically connected through a third contact hole CNT3. The third auxiliary electrode layer 18 may be electrically connected to the first electrode layer 13 of the first vibration portion 10A through the third connection portion 63.

Referring to FIGS. 2 to 6, in the second vibration portion 10B, the second auxiliary electrode layer 17 may be configured (or formed) on the vibration layer 11 to be electrically separated from the first electrode layer 13. The second auxiliary electrode layer 17 may be configured (or formed) on the second surface (or upper surface) of the vibration layer 11 to be electrically separated from the first electrode layer 13. For example, the second auxiliary electrode layer 17 may be configured (or formed) on the vibration layer 11 between a plurality of protrusion portions 13a and 13b in the first electrode layer 13.

In the second vibration portion 10B, the second auxiliary electrode layer 17 may be electrically connected to the second electrode layer 15 through the vibration layer 11. For example, the second auxiliary electrode layer 17 may be electrically connected to the first electrode layer 13 through a second contact hole CNT2 formed (or formed) in the vibration layer 11. For example, in the second vibration portion 10B, a second contact hole CNT2 overlapping the second auxiliary electrode layer 17 may be configured at one end (or one side) of the vibration layer 11. The second contact hole CNT2 may overlap the second electrode layer 15 and the second auxiliary electrode layer 17. The second connection portion 62 of a plurality of connection portions 60 may be inserted into the second contact hole CNT2. The second auxiliary electrode layer 17 and the second electrode layer 15 may be electrically connected through a second contact hole CNT2. The second auxiliary electrode layer 17 may be electrically connected to the second electrode layer 15 of the second vibration portion 10B through the second connection portion 62.

Referring to FIGS. 2, 7, and 8, in the second vibration portion 10B, the fourth auxiliary electrode layer 19 may be configured (or formed) under the vibration layer 11 to be electrically separated from the second electrode layer 15. The fourth auxiliary electrode layer 19 may be configured (or formed) on the first surface (or lower surface) of the vibration layer 11 to be electrically separated from the second electrode layer 15. For example, the fourth auxiliary electrode layer 19 may be configured (or formed) on the vibration layer 11 between a plurality of protrusion portions 15a and 15b in the second electrode layer 15. The fourth auxiliary electrode layer 19 may overlap the third auxiliary electrode layer 18 of the first vibration portion 10A.

In the second vibration portion 10B, the fourth auxiliary electrode layer 19 may be electrically connected to the first electrode layer 13 through the vibration layer 11. For example, the fourth auxiliary electrode layer 19 may be electrically connected to the first electrode layer 13 through a fourth contact hole CNT4 configured (or formed) in the vibration layer 11. For example, in the second vibration portion 10B, the fourth contact hole CNT4 overlapping the fourth auxiliary electrode layer 19 may be configured in the other end (or the other side) of the vibration layer 11. The fourth contact hole CNT4 may overlap the first electrode layer 13 and the third auxiliary electrode layer 18. A fourth connection portion 64 among a plurality of connection portions 60 may be inserted into the fourth contact hole CNT4. The fourth auxiliary electrode layer 19 and the first electrode layer 13 may be electrically connected through the fourth contact hole CNT4. The fourth auxiliary electrode layer 19 may be electrically connected to the first electrode layer 13 of the second vibration portion 10B through the fourth connection portion 64.

Referring to FIGS. 2 to 8, the first contact hole CNT1 and the third contact hole CNT3 may be spaced apart from each other in the second direction Y. For example, the first contact hole CNT1 and the third contact hole CNT3 may be spaced apart from each other by 180°. The second contact hole CNT2 and the fourth contact hole CNT4 may be spaced apart from each other in the second direction Y. For example, the second contact hole CNT2 and the fourth contact hole CNT4 may be spaced apart by 180°. Accordingly, the second electrode layer 15 of each of the first vibration portion 10A and the second vibration portion 10B may be configured to have the same shape, and the first electrode layer 13 of each of the first vibration portion 10A and the second vibration portion 10B may be configured to have the same shape. Accordingly, the vibration apparatus according to an embodiment of the present disclosure may configure the first and second electrode layers 13 and 15 without an additional electrode mask.

According to an embodiment of the present disclosure, the vibration apparatus 10 may include a connection layer 20 and an auxiliary connection layer 23. A plurality of vibration portions 10A and 10B or the first and second vibration portions 10A and 10B may be connected to or in contact with each other. A plurality of vibration portions 10A and 10B may be connected to each other through a connection layer 20 and an auxiliary connection layer 23 provided between a plurality of vibration portions 10A and 10B. For example, the plurality of vibration portions 10A and 10B or the first and second vibration portions 10A and 10B may be in contact with each other through the connection layer 20 and the auxiliary connection layer 23.

The second electrode layer 15 of the first vibration portion 10A may be connected to or electrically connected to the second electrode layer 15 of the adjacent second vibration portion 10B. The connection layer 20 may be electrically connected to the second electrode layer 15 between the vibration layer 11 of the first vibration portion 10A and the vibration layer 11 of the second vibration portion 10B. For example, the second electrode layer 15 of the first vibration portion 10A may be connected to or electrically connected to the second electrode layer 15 of the second vibration portion 10B through the connection layer 20.

According to an embodiment of the present disclosure, the connection layer 20 may include a conductive material. For example, the conductive material may include copper (Cu) or silver (Ag), and embodiments of the present disclosure are not limited thereto. According to an embodiment of the present disclosure, the connection layer 20 may be made of a glass frit containing silver (Ag). For example, the glass frit may include a PbO or Bi₂O₃-based material, but embodiments of the present disclosure are not limited thereto. For example, the glass frit may include any one of Bi, Zn, Al, B, and Si oxide, but embodiments of the present disclosure are not limited thereto. According to an embodiment of the present disclosure, the connection layer 20 may be an inner connection layer or an electrode connection layer, and embodiments of the present disclosure are not limited thereto.

According to an embodiment of the present disclosure, the connection layer 20 may include a plurality of protrusion portions (or a pair of protrusion portions) 20a and 20b protruding (or extending) from one end (or one side). A plurality of protrusion portions 20a and 20b may be spaced apart from each other and arranged in parallel. Accordingly, the connection layer 20 may not be formed in a region where a plurality of protrusion portions 20a and 20b are spaced apart from each other.

In another embodiment of the present disclosure, the connection layer 20 may include a concave portion concave from one end (or one side) of the connection layer 20. The concave portion may be formed to be concave in the second direction Y from the central portion of one end (or one side) of the connection layer 20. For example, the concave portion may be formed to have a constant length in the second direction Y from the central portion of one end (or one side) of the connection layer 20. For example, the concave portion may be configured between a plurality of protrusion portions (or a pair of protrusion portions) 20a and 20b, but embodiments of the present disclosure are not limited thereto. For example, since the concave portion is a portion in which the connection layer 20 is not formed, the concave portion may be a patterning portion or an open portion, but embodiments of the present disclosure are not limited thereto.

Referring to FIGS. 2, 7, and 8, the auxiliary connection layer 23 may be configured between the first vibration portion 10A and the second vibration portion 10B to be electrically separated from the connection layer 20. The auxiliary connection layer 23 may be configured between a plurality of protrusion portions (or a pair of protrusion portions) 20a and 20b protruding (or extending) from one end (or one side) of the connection layer 20. For example, the auxiliary connection layer 23 may be disposed on the same layer as the connection layer 20 and may be spaced apart from the connection layer 20. For example, the auxiliary connection layer 23 may be disposed in a concave portion formed between a plurality of protrusion portions (or a pair of protrusion portions) 20a and 20b.

According to an embodiment of the present disclosure, the auxiliary connection layer 23 may be disposed between the third auxiliary electrode layer 18 and the fourth auxiliary electrode layer 19. The auxiliary connection layer 23 may overlap the first and second auxiliary electrode layers 14 and 16. The auxiliary connection layer 23 may electrically connect the third and fourth auxiliary electrode layers 18 and 19. The auxiliary connection layer 23 may electrically connect the first electrode layer 13 of the first vibration portion 10A and the first electrode layer 13 of the second vibration portion 10B by using the third and fourth auxiliary electrode layers 18 and 19.

The auxiliary connection layer 23 may include the same material as the connection layer 20 and may be configured using the same process, but embodiments of the present disclosure are not limited thereto. For example, the auxiliary connection layer 23 may include the same amount of glass frit and silver (Ag) as the connection layer 20. Accordingly, since the auxiliary connection layer 23 includes the same material as the connection layer 20, redundant descriptions thereof will be omitted.

Referring to FIGS. 3 to 8, according to an embodiment of the present disclosure, each of a plurality of vibration portions 10A and 10B may include at least one or more connection portions 60. At least one or more connection portions 60 may be disposed in the vibration layer 11 of each of a plurality of vibration portions 10A and 10B. At least one or more connection portions 60 may be inserted into the vibration layer 11 of each of a plurality of vibration portions 10A and 10B. At least one or more connection portions 60 may be inserted into the contact holes CNT1 to CNT4 formed in the vibration layer 11. At least one or more connection portions 60 may not overlap the signal cable 90. At least one or more connection portions 60 may be spaced apart from the signal cable 90 in a first direction X or a second direction Y.

According to an embodiment of the present disclosure, at least one or more connection portions 60 may include first to fourth connection portions 16, 17, 18, and 19. Each of the first to fourth connection portions 16, 17, 18, and 19 may be inserted into each of the first to fourth contact holes CNT1, CNT2, CNT3, and CNT4. Each of the first to fourth connection portions 16, 17, 18, and 19 may not overlap the signal cable 90. The first and second connection portions 16 and 17 may be spaced apart from the signal cable 90 in the first direction X. The third and fourth connection portions 18 and 19 may be spaced apart from the signal cable 90 in the second direction Y.

The first vibration portion 10A may include at least one or more connection portions 60. For example, the first vibration portion 10A may include a first connection portion 61 and a third connection portion 63. The first connection portion 61 and the third connection portion 63 may be configured on the vibration layer 11 of the first vibration portion 10A. The first connection portion 61 and the third connection portion 63 may not overlap each other. The first connection portion 61 and the third connection portion 63 may be spaced apart from each other.

The first connection portion 61 may be disposed at one side of the vibration layer 11. The first connection portion 61 may be inserted into the first contact hole CNT1. The first connection portion 61 may electrically connect the first auxiliary electrode layer 16 to the second electrode layer 15 of the first vibration portion 10A. The first connection portion 61 may overlap the second connection portion 62 formed on the vibration layer 11 of the second vibration portion 10B.

The first connection portion 61 may include the same material as the first auxiliary electrode layer 16 and the second electrode layer 15. The first connection portion 61 may be formed by using the same process as the first auxiliary electrode layer 16 and/or the second electrode layer 15. In the process of forming the first auxiliary electrode layer 16 and/or the second electrode layer 15, the metal material constituting the first auxiliary electrode layer 16 and/or the second electrode layer 15 is inserted into the first contact hole CNT1 to form the first connection portion 61. The first connection portion 61 may be spaced apart from the signal cable 90 in the first direction X. The first connection portion 61 may not overlap the signal cable 90.

The third connection portion 63 may be disposed on one side and the other side of the vibration layer 11. The third connection portion 63 may be spaced apart from the first connection portion 61. The third connection portion 63 may be spaced apart from the first connection portion 61 in the second direction Y. The third connection portion 63 may be inserted into the third contact hole CNT3. The third connection portion 63 may electrically connect the third auxiliary electrode layer 18 to the first electrode layer 13 of the first vibration portion 10A. The third connection portion 63 may overlap the fourth connection portion 64 configured on the vibration layer 11 of the second vibration portion 10B.

The third connection portion 63 may include the same material as the third auxiliary electrode layer 18 and the first electrode layer 13. The third connection portion 63 may be formed using the same process as the third auxiliary electrode layer 18 and/or the first electrode layer 13. In the process of forming the third auxiliary electrode layer 18 and/or the first electrode layer 13, the metal material constituting the third auxiliary electrode layer 18 and/or the first electrode layer 13 is inserted into the third contact hole CNT3 to form the third connection portion 63. The third connection portion 63 may be spaced apart from the signal cable 90 in the second direction Y. The third connection portion 63 may not overlap the signal cable 90.

The second vibration portion 10B may include at least one or more connection portions 60. For example, the second vibration portion 10B may include a second connection portion 62 and a fourth connection portion 64. The second connection portion 62 and the fourth connection portion 64 may be configured on the vibration layer 11 of the second vibration portion 10B. The second connection portion 62 and the fourth connection portion 64 may not be overlapped.

The second connection portion 62 may be disposed at one side of the vibration layer 11. The second connection portion 62 may be inserted into the second contact hole CNT2. The second connection portion 62 may electrically connect the second auxiliary electrode layer 17 to the second electrode layer 15 of the second vibration portion 10B. The second connection portion 62 may be electrically connected to the first connection portion 61.

The second connection portion 62 may include the same material as the second auxiliary electrode layer 17 and the second electrode layer 15. The second connection portion 62 may be formed using the same process as the second auxiliary electrode layer 17 and/or the second electrode layer 15. In the process of forming the second auxiliary electrode layer 17 and/or the second electrode layer 15, the metal material constituting the second auxiliary electrode layer 17 and/or the second electrode layer 15 is inserted into the first contact hole CNT2 to form the second connection portion 62. The second connection portion 62 may be spaced apart from the signal cable 90 in the first direction X. The second connection portion 62 may not overlap the signal cable 90.

The fourth connection portion 64 may be disposed on one side and the other side of the vibration layer 11. The fourth connection portion 64 may be spaced apart from the second connection portion 62. The fourth connection portion 64 may be inserted into the fourth contact hole CNT4. The fourth connection portion 64 may electrically connect the fourth auxiliary electrode layer 19 to the first electrode layer 13 of the second vibration portion 10B. The fourth connection portion 64 may be electrically connected to the third connection portion 63.

The fourth connection portion 64 may include the same material as the fourth auxiliary electrode layer 19 and the first electrode layer 13. The fourth connection portion 64 may be formed using the same process as the fourth auxiliary electrode layer 19 and/or the first electrode layer 13. In the process of forming the fourth auxiliary electrode layer 19 and/or the first electrode layer 13, the metal material constituting the fourth auxiliary electrode layer 19 and/or the first electrode layer 13 is inserted into the fourth contact hole CNT4 to form the fourth connection portion 64. The fourth connection portion 64 may be spaced apart from the signal cable 90 in the second direction Y. The fourth connection portion 64 may not overlap the signal cable 90.

Referring to FIGS. 7 and 8, the first electrode layer 13 of the second vibration portion 10B may be electrically connected to the first electrode layer 13 of the first vibration portion 10A. For example, the first electrode layer 13 of the second vibration portion 10B may be electrically connected to the first electrode layer 13 of the first vibration portion 10A through a fourth connection portion 64, a fourth auxiliary electrode layer 19, an auxiliary connection layer 23, a third auxiliary electrode layer 18, and a third connection portion 63.

Referring to FIGS. 3 and 5, the second electrode layer 15 of the second vibration portion 10B may be electrically connected to the second auxiliary electrode layer 17 on the second surface (or upper surface) of the second vibration portion 10B through a second contact hole CNT2. The second electrode layer 15 of the second vibration portion 10B may be connected to the second electrode layer 15 of the first vibration portion 10A through the connection layer 20. The second electrode layer 15 of the second vibration portion 10B may be electrically connected to the connection layer 20, the second electrode layer 15 of the first vibration portion 10A, the first connection portion 61, and the first auxiliary electrode layer 16. Accordingly, the first auxiliary electrode layer 16 and the second auxiliary electrode layer 17 may be electrically connected to each other.

For example, the first connection portion 61 and the first auxiliary electrode layer 16 may be omitted. For example, in order to connect the second electrode layer 15 of the second vibration portion 10B and the second electrode layer 15 of the first vibration portion 10A, only the connection layer 20, the second connection portion 62, and the second auxiliary electrode layer 17 may be configured. In this case, the second electrode layer 15 of the second vibration portion 10B may be electrically connected to the second auxiliary electrode layer 17 on the second surface (or the upper surface) of the second vibration portion 10B through the second connection portion 62 and the second contact hole CNT2. The second electrode layer 15 of the second vibration portion 10B may be connected to the second electrode layer 15 of the first vibration portion 10A through the connection layer 20. However, when the first connection portion 61 and the first auxiliary electrode layer 16 are omitted, since the shapes of the vibration layer 11 and the first electrode layer 13 of each of the first vibration portion 10A and the second vibration portion 10B are different from each other, a metal pattern mask process may be added.

According to an embodiment of the present disclosure, the vibration apparatus includes a first connection portion 61 and a first auxiliary electrode layer 16, and has the same shape as the vibration layer 11 and the first electrode layer 13 of each of the first vibration portion 10A and the second vibration portion 10B, and thus the second electrode layer 15 of the second vibration portion 10B and the second electrode layer 15 of the first vibration portion 10A may be electrically connected to each other without adding a separate mask process.

Referring to FIGS. 2 to 8, the first electrode layer 13 of the second vibration portion 10B may be in contact with the first signal line 92a. Accordingly, the first electrode layer 13 of the second vibration portion 10B and the first electrode layer 13 of the first vibration portion 10A may be electrically connected to the first signal line 92a. The first electrode layer 13 of the second vibration portion 10B, the fourth connection portion 64, the fourth auxiliary electrode layer 19, the auxiliary connection layer 23, the third auxiliary electrode layer 18, the third connection portion 63, and the first electrode layer 13 of the first vibration portion 10A may be electrically connected to the first signal line 92a.

Accordingly, the embodiment of the present disclosure may apply the same signal to the first electrode layer 13 of the first vibration portion 10A and the first electrode layer 13 of the second vibration portion 10B by one signal line (e.g., the first signal line) without forming a separate signal line on the lower surface (or lower side) of the first electrode layer 13 of the first vibration portion 10A.

According to an embodiment of the present disclosure, the second auxiliary electrode layer 17 may be in contact with the second signal line 92b. Accordingly, the second electrode layer 15 of the second vibration portion 10B and the second electrode layer 15 of the first vibration portion 10A may be electrically connected to the second signal line 92b. The second auxiliary electrode layer 17, the second connection portion 62, the second electrode layer 15 of the second vibration portion 10B, the connection layer 20, the second electrode layer 15 of the first vibration portion 10A, the first connection portion 61, and the first auxiliary electrode layer 16 may be electrically connected to the second signal line 92b. For example, the second electrode layer 15 of the first vibration portion 10A and the second electrode layer 15 of the second vibration portion 10B may be an intermediate electrode layer, an inner electrode layer, and a common electrode layer of the vibration generating part 10, but embodiments of the present disclosure are not limited thereto.

According to an embodiment of the present disclosure, the vibration layer 11 of the first vibration portion 10A and the vibration layer 11 of the second vibration portion 10B may be polarized (or polled) in the same direction or in opposite (or different) directions. For example, the polarization direction (or polling direction) formed on the vibration layer 11 of the first vibration portion 10A may be a direction different from or opposite to the polarization direction (or polling direction) formed on the vibration layer 11 of the second vibration portion 10B.

According to an embodiment of the present disclosure, since the second electrode layer 15 of the first vibration portion 10A and the second electrode layer 15 of the second vibration portion 10B are connected to each other. Accordingly, when the polarization direction (or polling direction) formed in the vibration layer 11 of the first vibration portion 10A is opposite to the polarization direction (or polling direction) formed in the vibration layer 11 of the second vibration portion 10B, the first vibration portion 10A and the second vibration portion 10B may be displaced (or vibrated or driven) in the same direction, and thus the vibration width (or displacement width or driving width) of the vibration generating part 10 may be maximized, and thus the sound pressure of the vibration generating part 10 may be improved.

The vibration generating part 10 according to an embodiment of the present disclosure may further include a first cover member 30 and a second cover member 50.

The first cover member 30 may be configured to cover or protect one surface of the vibration generating part 10. For example, in the vibration generating part 10, one surface may be a lower surface, a rear surface, a last surface, a rear surface, or a rear surface. For example, the first cover member 30 may be configured to cover or protect the first surface of the vibration generating part 10. For example, in the vibration generating part 10, the first surface may be a lower surface, a rear surface, a last surface, a rear surface, or a rear surface.

The first cover member 30 may be configured to cover the first vibration portion 10A of the vibration generating part 10. For example, the first cover member 30 may be configured to cover the first electrode layer 13, the first auxiliary electrode layer 16, and the third auxiliary electrode layer 18 of the first vibration portion 10A. Therefore, the first cover member 30 may protect the first surface of the vibration generating part 10 and the first electrode layer 13 of the first vibration portion 10A, the first auxiliary electrode layer 16, and the third auxiliary electrode layer 18.

The first cover member 30 according to an embodiment of the present disclosure may include an adhesive member. For example, the first cover member 30 may include a base cover member, and an adhesive member that is disposed on the base cover member and is connected to or coupled to the first surface of the vibration generating part 10 and the first electrode layer 13 of the first vibration portion 10A. For example, the adhesive member may include an electrical insulating material having an adhesive property and capable of being compressed and restored.

The first cover member 30 according to another embodiment of the present disclosure may be connected to or coupled to the first surface of the vibration generating part 10 via an adhesive layer 40. For example, the first cover member 30 may be connected to or coupled to at least a part of the first surface of the vibration generating part 10 or the first electrode layer 13 of the first vibration portion 10A via the first adhesive layer 41 of the adhesive layer 40. For example, the first cover member 30 may be connected to or coupled to at least a part of the first surface of the vibration generating part 10 or the first electrode layer 13 of the first vibration portion 10A by a film laminating process using the first adhesive layer 41.

The second cover member 50 may be configured to cover or protect the other surface different from the one surface of the vibration generating part 10. For example, in the vibration generating part 10, the other surface may be an upper surface, an uppermost surface, a front surface, or a front surface portion. For example, the second cover member 50 may be configured to cover or protect the second surface of the vibration generating part 10. For example, in the vibration generating part 10, the second surface may be an upper surface, an uppermost surface, a front surface, or a front surface portion.

The second cover member 50 may be configured to cover the second vibration portion 10B of the vibration generating part 10. For example, the second cover member 50 may be configured to cover the first electrode layer 13 of the second vibration portion 10B, the second auxiliary electrode layer 17, and the fourth auxiliary electrode layer 19. Therefore, the second cover member 50 may protect the second surface of the vibration generating part 10 and the first electrode layer 13 of the second vibration portion 10B, the second auxiliary electrode layer 17, and the fourth auxiliary electrode layer 19.

The second cover member 50 according to an embodiment of the present disclosure may include an adhesive member. For example, the second cover member 50 may include a base cover member, and an adhesive member disposed on the base cover member and connected or coupled to the second surface of the vibration generating part 10 and the first electrode layer 13 of the second vibration portion 10A. For example, the adhesive member may include an electrical insulating material having an adhesive property and capable of being compressed and restored.

The second cover member 50 according to another embodiment of the present invention may be connected to or coupled to the second surface of the vibration generating part 10 via an adhesive layer 40. For example, the second cover member 50 may be connected to or coupled to at least a part of the second surface of the vibration generating part 10 or the first electrode layer 13 of the second vibration portion 10B via the second adhesive layer 42 of the adhesive layer 40. For example, the second cover member 50 may be connected to or coupled to at least a part of the second surface of the vibration generating part 10 or the first electrode layer 13 of the second vibration portion 10B by a film laminating process using the second adhesive layer 42.

Each of the first cover member 30 and the second cover member 50 according to an embodiment of the present disclosure may include at least one of plastic, fiber, cloth, paper, leather, rubber, carbon, and wood, but embodiments of the present disclosure are not limited thereto. For example, each of the first cover member 30 and the second cover member 50 may include the same or different materials. For example, each of the first cover member 30 and the second cover member 50 may be a polyimide film, a polyethylene naphthalate film, or a polyethylene terephthalate film, but embodiments of the present disclosure are not limited thereto.

The first adhesive layer 41 and the second adhesive layer 42 (or the adhesive layer 40) according to an embodiment of the present disclosure may include an electrical insulating material having adhesive properties, which may be compressed and restored. For example, the first adhesive layer 41 and the second adhesive layer 42 (or the adhesive layer 40) may include an inkjet and a thermal/photo-curable adhesive. For example, the first adhesive layer 41 and the second adhesive layer 42 (or the adhesive layer 40) may include epoxy resin, acrylic resin, silicone resin, urethane resin, press sensitive adhesive (PSA), optically clear adhesive (OCA), or optically clear resin (OCR), but embodiments of the present disclosure are not limited thereto. For example, the first adhesive layer 41 and the second adhesive layer 42 or the adhesive layer 40 may be configured to surround or completely surround the vibration generating part 10. The first adhesive layer 41 and the second adhesive layer 42 or the adhesive layer 40 may be configured to cover or surround all surfaces of the vibration generating part 10. For example, the vibration generating part 10 may be inserted (or accommodated) into the adhesive layer 40 or embedded in the adhesive layer 40.

According to an embodiment of the present disclosure, any one of the first cover member 30 and the second cover member 50 may be omitted. For example, among the first cover member 30 and the second cover member 50, the first cover member 30 may be omitted. When the first cover member 30 is omitted, the first surface of the vibration generating part 10 may be covered or surrounded by the adhesive layer 40 or the first adhesive layer 41. Accordingly, the first surface of the vibration generating part 10 may be covered or protected by the adhesive layer 40 or the first adhesive layer 41. When the first cover member 30 is omitted, the second cover member 50 may be a cover member, a cover film, a protective member, or a protective film.

The vibration apparatus according to the embodiment of the present disclosure may further include a signal cable 90.

The signal cable 90 may be electrically connected to a plurality of vibration portions 10A and 10B. The signal cable 90 may be electrically connected to each of the first and second vibration portions 10A and 10B of the vibration generating part 10 at one side of the vibration generating part 10. The signal cable 90 may be electrically connected to each of the first and second vibration portions 10A and 10B between the first and second cover members 30 and 50.

An end of the signal cable 90 may be disposed or inserted (or accommodated) between one edge of the first cover member 30 and one edge of the second cover member 50. One edge portion of the first cover member 30 and one edge portion of the second cover member 50 may accommodate a part of the signal cable 90 or may vertically cover the signal cable 90. Accordingly, the signal cable 90 may be integrated with the vibration generating part 10. For example, the vibration apparatus according to the embodiment of the present disclosure may be a vibration apparatus in which the signal cable 90 is integrated. For example, the signal cable 90 may be composed of a flexible cable, a flexible printed circuit cable, a flexible flat cable, a single-sided flexible printed circuit, a single-sided flexible printed circuit board, a flexible multilayer printed circuit board, or a flexible multilayer printed circuit board, but embodiments of the present disclosure are not limited thereto.

The signal cable 90 according to an embodiment of the present disclosure may include a base member 91 and a plurality of signal lines 92a and 92b. For example, the signal cable 90 may include a base member 91, a first signal line 92a, and a second signal line 92b.

The base member 91 may include a transparent or opaque plastic material. For example, the base member 91 may be made of at least one of a synthetic resin including a fluorine resin, a polyimide-based resin, a polyurethane-based resin, a polyester-based resin, a polyethylene-based resin, and a polypropylene-based resin, but embodiments of the present specification are not limited thereto. The base member 91 may be a base film or a base insulating film, and embodiments of the present disclosure are not limited thereto.

The base member 91 has a constant width along the first direction X and may extend long along the second direction Y crossing the first direction X.

Each of the first and second signal lines 92a and 92b is disposed on the first surface of the base member 91 to be parallel to the second direction Y, and may be spaced apart from each other or separated from each other along the first direction X. Each of the first and second signal lines 92a and 92b may be disposed parallel to each other on the first surface of the base member 91. For example, each of the first and second signal lines 92a and 92b may be implemented in a line shape by patterning a metal layer (or conductive layer) formed or deposited on the first surface of the base member 91.

End portions (or end portions) of each of the first and second signal lines 92a and 92b may be individually bent by being separated from each other.

According to an embodiment of the present disclosure, an end of the first signal line 92a may be disposed between the second cover member 50 and the second surface of the vibration generating part 10. For example, an end of the first signal line 92a may be configured to be electrically connected to the uppermost electrode layer (or the first electrode layer) 13 of the vibration generating part 10. For example, an end of the first signal line 92a electrically connected to the uppermost electrode layer (or the first electrode layer) 13 of the vibration generating part 10 may be covered by the adhesive layer 40 or the second adhesive layer 42, but embodiments of the present disclosure are not limited thereto.

An end portion of the first signal line 92a may be electrically connected to at least a portion of the first electrode layer 13 of the second vibration portion 10B, which is the uppermost electrode layer 13 of the vibration generating part 10. For example, the first signal line 92a may be electrically connected to the first electrode layer 13 of the second vibration portion 10B and the first electrode layer 13 of the first vibration portion 10A. The first signal line 92a may be electrically connected to the first electrode layer 13 of the second vibration portion 10B, the fourth connection portion 64, the fourth auxiliary electrode layer 19, the auxiliary connection layer 23, the third auxiliary electrode layer 18, the third connection portion 63, and the first electrode layer 13 of the first vibration portion 10A.

Accordingly, the first signal line 92a may commonly supply the driving signal supplied from the vibration driving circuit to the first electrode layer 13 of the second vibration portion 10A and the first electrode layer 13 of the first vibration portion 10A. Accordingly, the vibration apparatus according to the embodiment of the present disclosure does not configure two separate signal lines connected to each of the first electrode layer 13 of the first vibration portion 10A and the first electrode layer 13 of the second vibration portion 10B. Therefore, the same signal may be applied to the first electrode layer 13 oaf the first vibration portion 10A and the first electrode layer 13 of the second vibration portion 10B by using one first signal line 92a. According to an embodiment of the present disclosure, the signal line 90 may not overlap the connection portion 60.

The first signal line 92a may not overlap the third and fourth connection portions 63 and 64. The first signal line may be spaced apart from the third and fourth connection portions 63 and 64 in the second direction Y. The first signal line 92a may not overlap the third and fourth contact holes CNT3 and CNT4 into which the third and fourth connection portions 63 and 64 are inserted, respectively. The first signal line 92a may be spaced apart from the third and fourth contact holes CNT3 and CNT4 into which the third and fourth connection portions 63 and 64 are inserted, respectively, in the second direction Y.

For example, when a contact hole is formed in a vibration layer, an electrode material used as an electrode layer is filled in the contact hole to connect the upper and lower electrode layers to the contact hole. However, during the ceramic sintering process, the electrode material filled in the contact hole contracts, and thus a concave groove may be formed in the upper portion of the contact hole. When a signal cable is connected to the upper portion of the contact hole, an air-gap may be formed by the groove between the upper portion of the contact hole and the signal cable. In this case, an arc discharge may occur between the contact hole and the signal cable due to the air gap in the process of performing a polarization process of applying a high voltage to impart piezoelectricity to the vibration apparatus. When arc discharge occurs through the air gap, a burn defect may occur in the vibration apparatus. In addition, due to a burn defect, damage such as cracks may occur on the surface of the electrode layer and the vibration layer (or piezoelectric ceramic) of the vibration generating part. To prevent this, a process of separately filling the contact hole may be added, but the process may be complicated and the cost may be increased.

According to an embodiment of the present disclosure, the first signal line 92a may not overlap the third connection portion 63 and the fourth connection portion 64, or the third contact hole CNT3 and the fourth contact hole CNT4. Accordingly, the occurrence of an air gap between the third contact hole CNT3 and the fourth contact hole CNT4 and the first signal line 92a may be prevented.

Accordingly, burnt defects and cracks of the vibration apparatus may be prevented without increasing process and cost. Accordingly, by preventing defects such as cracks occurring in the vibration apparatus, yield can be improved, and process optimization can be implemented through reduction of production energy.

According to an embodiment of the present disclosure, an end portion of the second signal line 92b may be disposed between the second cover member 50 and the second surface of the vibration generating part 10. For example, an end portion of the second signal line 92b may be configured to be electrically connected to the second auxiliary electrode layer 17 electrically separated from the uppermost electrode layer 13 of the vibration generating part 10. For example, an end portion of the second signal line 92b electrically connected to the second auxiliary electrode layer 17 of the vibration generating part 10 may be covered by the adhesive layer 40 or the second adhesive layer 42, but embodiments of the present disclosure are not limited thereto. For example, an end portion of the second signal line 92b electrically connected to the second auxiliary electrode layer 17 of the vibration generating part 10 may be in contact with or in direct contact with the second cover member 50 without being covered by the adhesive layer 40 or the second adhesive layer 42.

An end portion of the second signal line 92b may be electrically connected to the second auxiliary electrode layer 17 electrically separated from the uppermost electrode layer 13 of the vibration generating part 10. For example, an end portion of the second signal line 92b may be configured to be electrically connected to at least a portion of the second auxiliary electrode layer 17. For example, the second signal line 92b may be electrically connected to the second auxiliary electrode layer 17, the second connection portion 62, the second electrode layer 15 of the second vibration portion 10B, the connection layer 20, the second electrode layer 15 of the first vibration portion 10A, the first connection portion 61, and the first auxiliary electrode layer 16. For example, the second signal line 92b may be connected to the second electrode layer 15 of the second vibration portion 10B and the second electrode layer 15 of the first vibration portion 10A through the second auxiliary electrode layer 17.

The signals applied to the second signal line 92b may be supplied to the second electrode layer 15 of the first vibration portion 10A through the second auxiliary electrode layer 17, the second connection portion 62, the second electrode layer 15 of the second vibration portion 10B, and the connection layer 20. Accordingly, the second signal line 92b may commonly supply the driving signal supplied from the vibration driving circuit to the second electrode layer 15 of the second vibration portion 10B and the second electrode layer 15 of the first vibration portion 10A.

The vibration apparatus according to the embodiment of the present disclosure does not constitute two separate signal lines connected to each of the second electrode layer 15 of the first vibration portion 10A and the second electrode layer 15 of the second vibration portion 10B, but may apply the same signal to the second electrode layer 15 of the first vibration portion 10A and the second electrode layer 15 of the second vibration portion 10B by using one second signal line 92b.

According to an embodiment of the present disclosure, the second signal line 92b may not overlap the first connection portion 61 and the second connection portion 62. The second signal line 92b may be spaced apart from the first connection portion 61 and the second connection portion 62 in the first direction X. The second signal line 92b may not overlap the first contact hole CNT1 and the second contact hole CNT2 into which the first connection portion 61 and the second connection portion 62 are inserted, respectively. The second signal line 92b may be spaced apart from the first contact hole CNT1 and the second contact hole CNT2 into which the first connection portion 61 and the second connection portion 62 are inserted, respectively, in the first direction X.

The first auxiliary electrode layer 16 and the second auxiliary electrode layer 17 may be formed to be concave in the Z-axis direction in a region overlapping the first contact hole CNT1 and the second contact hole CNT2 by the first contact hole CNT1 and the second contact hole CNT2. A region where the first auxiliary electrode layer 16 and the second auxiliary electrode layer 17 overlap the first contact hole CNT1 and the second contact hole CNT2 may be formed to be concave. When the first connection portion 61 and the second connection portion 62 are disposed in the concavely formed region, an air gap may be formed.

According to an embodiment of the present disclosure, since the second signal line 92b does not overlap the first connection portion 61 and the second connection portion 62, or the first contact hole CNT1 and the second contact hole CNT2, an air gap may be prevented from occurring between the first contact hole CNT1 and the second contact hole CNT2 and the second signal line 92b.

Accordingly, burn defects and cracks of the vibration apparatus may be prevented without increasing the process and cost. Accordingly, defects such as cracks occurring in the vibration apparatus may be prevented, thereby improving yield and realizing process optimization through reduction of production energy.

In the first vibration portion 10A, the first electrode layer 13 may receive a driving signal through the first signal line 92a, and the second electrode layer 15 may receive a driving signal through the second signal line 92b. Accordingly, the first vibration portion 10A may vibrate (or displace or drive) by alternately repeating contraction and/or expansion by a reverse piezoelectric effect generated in the vibration layer 11 according to a driving signal.

In the second vibration portion 10B, the first electrode layer 13 may receive a driving signal through the first signal line 92a, and the second electrode layer 15 may receive a driving signal through the second signal line 92b. Accordingly, the second vibration portion 10B may vibrate (or displace or drive) by alternately repeating contraction and/or expansion by a reverse piezoelectric effect generated in the vibration layer 11 according to a driving signal.

Each of the first vibration portion 10A and the second vibration portion 10B may be bent (or displaced or driven) in the same shape. Accordingly, the vibration generating part 10 or the vibration apparatus may be maximized by adding the vibration width (or displacement width or driving width) of the first vibration portion 10A and the vibration width (or displacement width or driving width) of the second vibration portion 10B. For example, in the vibration generating part 10 or the vibration apparatus, vibration efficiency or vibration characteristics may be improved and the vibration width (or displacement width or driving width) may be maximized by reinforcing the vibration of the first vibration portion 10A and the vibration of the second vibration portion 10B. Accordingly, acoustic characteristics and/or sound pressure characteristics including low-pitched sound band may be improved.

The signal cable 90 may include first and second extension portions 91a and 91b supporting end portions of each of the first and second signal lines 92a and 92b separated from each other. For example, each of the first and second extension portions 91a and 91b may be separated from each other between edge portions of one side of the second cover member 50. Accordingly, the end portions of each of the first and second signal lines 92a and 92b may be individually bent by being separated from each other.

According to an embodiment of the present disclosure, each of the first and second extension portions 91a and 91b of the signal cable 90 may be omitted. For example, each of the first and second signal lines 92a and 92b may protrude or extend from the base member 91 in a finger shape, and may be electrically connected or in contact with the electrode layers 13 and 17 corresponding to one edge portion of the second cover member 50, respectively. For example, the ends of the first and second signal lines 92a and 92b may be electrically connected to or in contact with their corresponding electrode layers 13 and 17 via conductive double-sided tape, thereby ensuring adhesion to the respective electrode layers 13 and 17.

The signal cable 90 according to an embodiment of the present disclosure may further include an insulation member 93.

The insulation member 93 may be disposed on the first surface of the base member 91 to cover each of the first and second signal lines 92a and 92b except for an end portion of the signal cable 90. The insulation member 93 may be a protective layer, a coverlay, a coverlay layer, a cover film, an insulation film, or a solder mask, but the embodiments of the present disclosure are not limited thereto.

The end of the signal cable 90 is inserted (or accommodated) and fixed between the second cover member 50 and the vibration generating part 10, and thus a connection failure between the vibration generating part 10 and the signal cable 90 due to the flow of the signal cable 90 may be prevented.

In the vibration apparatus according to the embodiment of present disclosure, since the first and second signal lines 92a and 92b of the signal cable 90 are inserted between the second cover member 50 and the vibration generating part 10, a soldering process for electrical connection between the vibration generating part 10 and the signal cable 90 is not required. Accordingly, the structure and manufacturing process of the vibration apparatus can be simplified.

In addition, the vibration apparatus according to the embodiment of the present disclosure includes a plurality of vibration portion 10A and 10B overlapped or stacked on each other to vibrate (or displace or drive) in the same direction. Accordingly, vibration efficiency or vibration characteristics of the vibration apparatus may be improved, vibration width (or displacement width or driving width) may be maximized, and acoustic characteristics and/or sound pressure characteristics including low-pitched sound band may be improved.

In addition, in the vibration apparatus according to the embodiment of the present disclosure, the signal line is not configured between the plurality of vibration portions 10A and 10B, and thus the thickness of the vibration apparatus and the step coverage due to the signal line may be reduced. In addition, the vibration apparatus according to an embodiment of the present disclosure may prevent a crack generated when the first cover member 30 and the second cover member 50 are attached due to a step coverage generated when the signal line is connected. For example, in the vibration apparatus according to the embodiment of present disclosure, both the first and second signal lines 92a and 92b are configured on the upper surface of the vibration generating part 10. Accordingly, when the signal line is configured between the first and second vibration portions 10A and 10B, the ceramic constituting the first and second vibration portions 10A and 10B may be prevented from being broken or a defect such as a crack may be prevented by the attachment of the first and second vibration portions 10A and 10B.

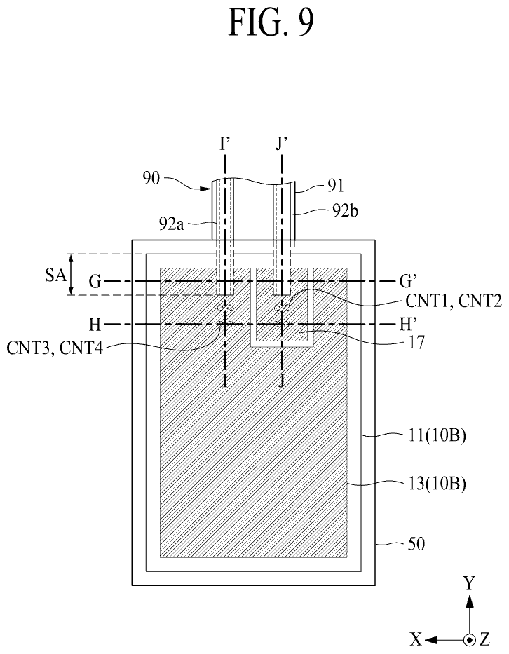

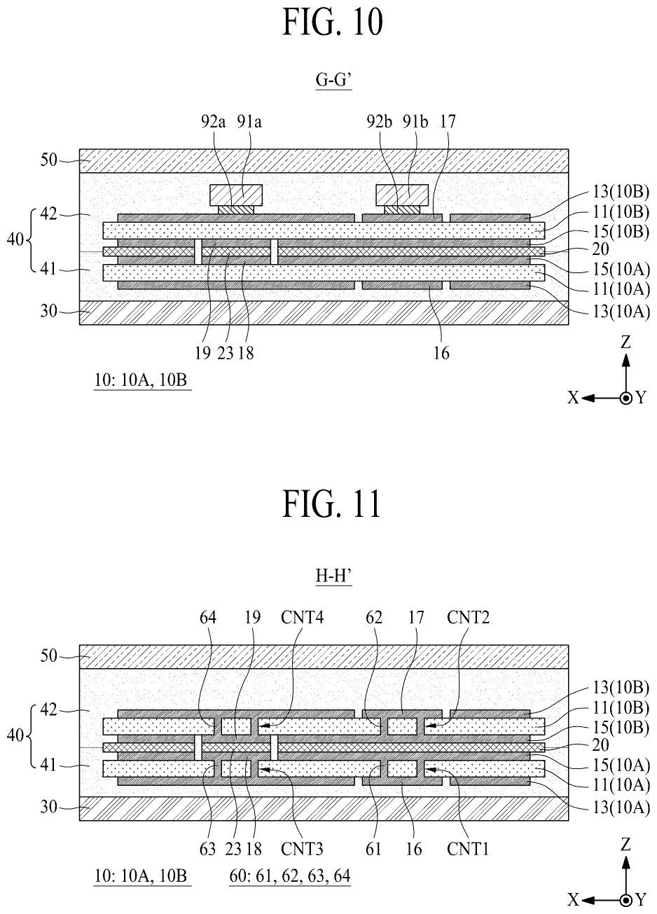

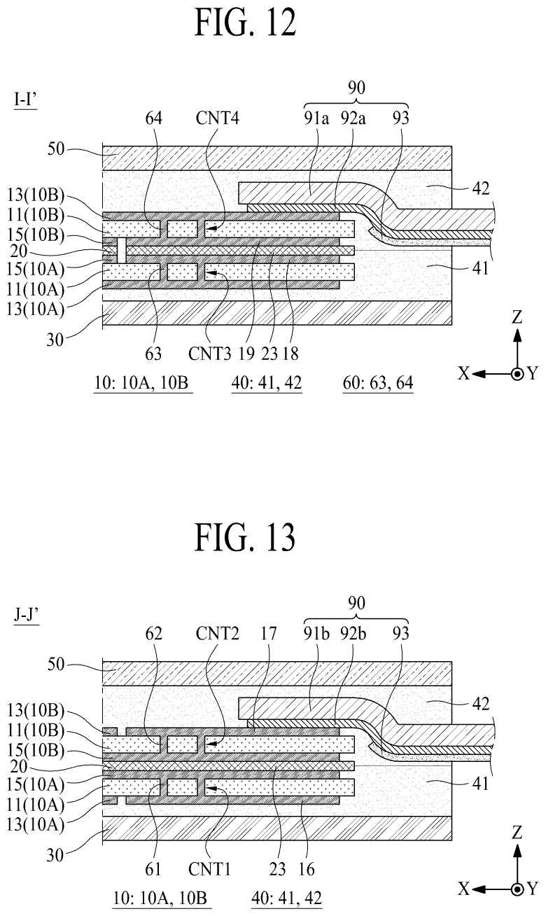

FIG. 9 is a diagram illustrating a vibration apparatus according to another embodiment of the present disclosure. FIG. 10 is a cross-sectional view taken along the line G-G′ shown in FIG. 9. FIG. 11 is a cross-sectional view taken along the line H-H′ shown in FIG. 9. FIG. 12 is a cross-sectional view taken along the line I-I′ shown in FIG. 9. FIG. 13 is a cross-sectional view taken along a line J-J′ shown in FIG. 9. This is a change in the positions of the contact hole and the connection portion in the vibration apparatus illustrated in FIGS. 1 to 8. Therefore, in the following description, only the contact hole, the connection portion, and a configuration related thereto will be described, and the remaining configurations will be given the same reference numerals as in FIGS. 1 to 8, and redundant descriptions thereof will be simply described or omitted.

Referring to FIGS. 9 to 13, a vibration apparatus according to another embodiment of the present disclosure may include a vibration generating part 10, a connection layer 20, a connection portion 60, and a signal cable 90.

According to another embodiment of the present disclosure, in the first vibration portion 10A, the first electrode layer 13 may include a plurality of protrusion portions 13a and 13b protruding (or extending) from one end (or one side). In the first vibration portion 10A, the second electrode layer 15 may include a plurality of protrusion portions 15a and 15b protruding (or extending) from one end (or one side). In the first vibration portion 10A, a plurality of protrusion portions 13a and 13b of the first electrode layer 13 and a plurality of protrusion portions 15a and 15b of the second electrode layer 15 may all be configured at one end (or one side) of the vibration generating part 10.

In the second vibration portion 10B, the first electrode layer 13 may include a plurality of protrusions (or a pair of protrusions) 13a and 13b protruding (or extending) from one end (or one side). In the second vibration portion 10B, the second electrode layer 15 may include a plurality of protrusions (or a pair of protrusions) 15a and 15b protruding (or extending) from one end (or one side). In the second vibration portion 10B, a plurality of protrusions (or a pair of protrusions) 13a and 13b of the first electrode layer 13 and a plurality of protrusions (or a pair of protrusions) 15a and 15b of the second electrode layer 15 may all be configured at one end (or one side) of the vibration generating part 10.

According to another embodiment of the present disclosure, the connection layer 20 may include a plurality of protrusion portions (or a pair of protrusion portions) 20a and 20b protruding (or extending) from one end (or one side). A plurality of protrusion portions 20a and 20b may be spaced apart from each other and arranged in parallel. Accordingly, the connection layer 20 may not be configured in a region where a plurality of protrusion portions 20a and 20b are spaced apart from each other.

The auxiliary connection layer 23 may be configured between the first vibration portion 10A and the second vibration portion 10B to be electrically separated from the connection layer 20. The auxiliary connection layer 23 may be disposed between the third and fourth auxiliary electrode layers 18 and 19. The auxiliary connection layer 23 may overlap the first and second auxiliary electrode layers 14 and 16.

According to another embodiment of the present disclosure, the vibration generating part 10 may include a plurality of auxiliary electrode layers 16, 17, 18, and 19. All of a plurality of auxiliary electrode layers 16, 17, 18, and 19 may be configured at one end (or one side) of the vibration generating part 10.

According to another embodiment of the present disclosure, the first vibration portion 10A may include a first contact hole CNT1 and a third contact hole CNT3 spaced apart from each other at one side of the vibration layer 11, and the second vibration portion 10B may include a second contact hole CNT2 and a fourth contact hole CNT4 spaced apart from each other at one side of the vibration layer 11. The first vibration portion 10A may include a first contact hole CNT1 and a third contact hole CNT3 parallel to each other in the first direction X at one end (or one side) of the vibration layer 11. The second vibration portion 10B may include a second contact hole CNT2 and a fourth contact hole CNT4 parallel to each other in the first direction X at one end (or one side) of the vibration layer 11. Each of the first to fourth connection portions 16, 17, 18, and 19 may be inserted into each of the first to fourth contact holes CNT1 to CNT4.

In the first vibration portion 10A, the first auxiliary electrode layer 16 may be formed or configured under the vibration layer 11 to be electrically separated from the first electrode layer 13. For example, in the first vibration portion 10A, a first contact hole CNT1 overlapping the first auxiliary electrode layer 16 may be configured at one end (or one side) of the vibration layer 11. The first connection portion 61 may be inserted into the first contact hole CNT. The first auxiliary electrode layer 16 may be electrically connected to the second electrode layer 15 of the first vibration portion 10A through the first connection portion 61.

In the first vibration portion 10A, the third auxiliary electrode layer 18 may be configured (or formed) on the vibration layer 11 to be electrically separated from the second electrode layer 15. For example, in the first vibration portion 10A, a third contact hole CNT3 overlapping the third auxiliary electrode layer 18 may be configured at one end (or one side) of the vibration layer 11. The third contact hole CNT3 may be spaced apart from the first contact hole CNT1. The third contact hole CNT3 may be disposed in parallel with the first contact hole CNT1 in the first direction X. The third connection portion 63 may be inserted into the third contact hole CNT3. The third connection portion 63 may be spaced apart from the first connection portion 61. The third connection portion 63 may be disposed in parallel with the first connection portion 61 in the first direction X. The third auxiliary electrode layer 18 may be electrically connected to the first electrode layer 13 of the first vibration portion 10A through the third connection portion 63.

In the second vibration portion 10B, the second auxiliary electrode layer 17 may be configured (or formed) on the vibration layer 11 to be electrically separated from the first electrode layer 13. For example, in the second vibration portion 10B, a second contact hole CNT2 overlapping the second auxiliary electrode layer 17 may be formed at one end (or one side) of the vibration layer 11. The second connection portion 62 may be inserted into the second contact hole CNT2. The second auxiliary electrode layer 17 may be electrically connected to the second electrode layer 15 of the second vibration portion 10B through the second connection portion 62.

In the second vibration portion 10B, the fourth auxiliary electrode layer 19 may be configured (or formed) under the vibration layer 11 to be electrically separated from the second electrode layer 15. For example, in the second vibration portion 10B, a fourth contact hole CNT4 overlapping the fourth auxiliary electrode layer 19 may be configured at one end (or one side) of the vibration layer 11. The fourth contact hole CNT4 may be spaced apart from the second contact hole CNT2. The fourth contact hole CNT4 may be disposed in parallel with the second contact hole CNT2 in the first direction X. The fourth connection portion 64 may be inserted into the fourth contact hole CNT4. The fourth connection portion 64 may be spaced apart from the second connection portion 62. The fourth connection portion 64 may be disposed in parallel with the second connection portion 62 in the first direction X. The fourth auxiliary electrode layer 19 may be electrically connected to the first electrode layer 13 of the second vibration portion 10B through the fourth connection portion 64.

Each of the first to fourth contact holes CNT1 to CNT4 may be formed in the remaining portions except for an edge portion (or a periphery portion) of the vibration layer 11. A separation area SA for attaching the signal cable 90 may be configured between each of the first to fourth contact holes CNT1 to CNT4 and one side surface of the vibration layer 11. For example, the first to fourth contact holes CNT1 to CNT4 may not be configured in the separation area SA.

According to another embodiment of the present disclosure, the signal cable 90 may not overlap each of the first to fourth contact holes CNT1 to CNT4. The signal cable 90 may be spaced apart from each of the first to fourth contact holes CNT1 to CNT4 in the second direction Y. The signal cable 90 may not overlap each of the first to fourth connection portions 16, 17, 18, and 19. The signal cable 90 may be spaced apart from each of the first to fourth connection portions 16, 17, 18, and 19 in the second direction Y.

The signal cable 90 may be connected to the separation area SA between each of the first to fourth contact holes CNT1 to CNT4 and the side surface of the vibration layer 11. The signal cable 90 may be attached to the separation area SA between each of the first to fourth contact holes CNT1 to CNT4 and the side surface of the vibration layer 11.

The first signal line 92a does not overlap the third contact hole CNT3 and the fourth contact hole CNT4, and may be in contact with the separation area SA. The first signal line 92a does not overlap the third and fourth connection portions 63 and 64, and may be in contact with the separation area SA. The second signal line 92b does not overlap the first contact hole CNT1 and the second contact hole CNT2, and may be in contact with the separation area SA. The second signal line 92b does not overlap the first and second connection portions 61 and 62, and may be in contact with the separation area SA.

According to another embodiment of the present disclosure, the first signal line 92a does not overlap the third connection portion 63 and the fourth connection portion 64, or the third contact hole CNT3 and the fourth contact hole CNT4, and thus an air gap may be prevented from occurring between the third contact hole CNT3 and the fourth contact hole CNT4 and the first signal line 92a. In addition, the second signal line 92b does not overlap the first connection portion 61 and the second connection portion 62, or the first contact hole CNT1 and the second contact hole CNT2, and thus an air gap may be prevented from occurring between the first contact hole CNT1 and the second contact hole CNT2 and the second signal line 92b.

Accordingly, burnt defects and cracks of the vibration apparatus may be prevented without an increase in process and cost. Accordingly, defects such as cracks occurring in the vibration apparatus may be prevented, and thus yield may be improved and process optimization may be implemented through reduction of production energy.

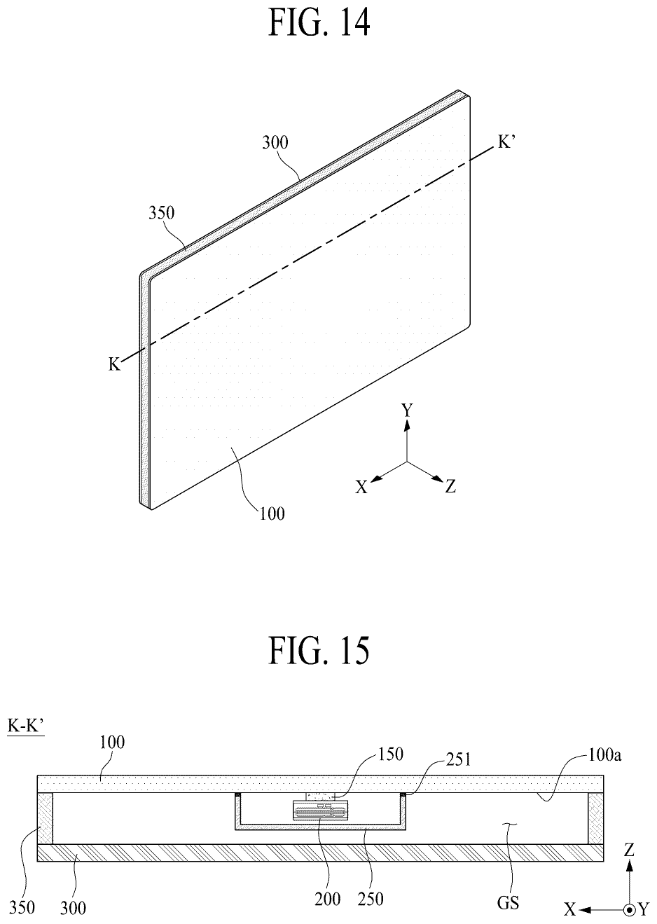

FIG. 14 is a diagram illustrating an apparatus according to an embodiment of the present disclosure. FIG. 15 is a cross-sectional view taken along a line K-K′ illustrated in FIG. 14.

Referring to FIGS. 14 and 15, an apparatus according to an embodiment of the present disclosure may include a passive vibration member 100 and one or more vibration generating apparatus 200.

The apparatus according to an embodiment of the present disclosure may be a display apparatus, a sound apparatus, a sound generating apparatus, a sound bar, an analog signage, or a digital signage, or the like, but embodiments of the present disclosure are not limited thereto.

The display apparatus may include a display panel including a plurality of pixels which implement a black/white or color image, and a driver configured to drive the display panel. An image according to an embodiment of the present disclosure may include an electronic image, a digital image, a still image, or a video image, but embodiments of the present disclosure are not limited thereto. For example, the display panel may be an organic light emitting display panel, a light emitting diode display panel, an electrophoresis display panel, an electro-wetting display panel, a micro light emitting diode display panel, or a quantum dot light emitting display panel, or the like, but embodiments of the present disclosure are not limited thereto. For example, in the organic light emitting display panel, a pixel may include an organic light emitting device such as an organic light emitting layer or the like, and the pixel may be a subpixel which implements any one of a plurality of colors configuring a color image. Therefore, an apparatus according to an embodiment of the present disclosure may include a set device (or a set apparatus) or a set electronic device such as a notebook computer, a television (TV), a computer monitor, an equipment apparatus including an automotive apparatus or another type apparatus for vehicles, or a mobile electronic device such as a smartphone, or an electronic pad, or the like which is a complete product (or a final product) including a display panel such as an organic light emitting display panel, a liquid crystal display panel, or the like.

The analog signage may be an advertising signboard, a poster, a noticeboard, or the like. The analog signage may include content such as a sentence, a picture, and a sign, or the like. The content may be disposed at the passive vibration member 100 of the apparatus to be visible. The content may be directly attached on the passive vibration member 100 and the content may be printed or the like on a medium such as paper, and the medium may be attached on the passive vibration member 100.

The passive vibration member 100 may vibrate based on driving (or vibration) of the one or more vibration generating apparatuses 200. For example, the passive vibration member 100 may generate one or more of a vibration and a sound based on driving of the one or more vibration generating apparatuses 200.

The passive vibration member 100 according to an embodiment of the present disclosure may be a display panel including a display area (or a screen) having a plurality of pixels which implement a black/white or color image. Thus, the passive vibration member 100 may generate one or more of a vibration and a sound based on driving of the one or more vibration generating apparatuses 200. For example, the passive vibration member 100 may vibrate based on a vibration of the vibration generating apparatus 200 while a display area is displaying an image, and thus, may generate or output a sound synchronized with the image displayed on the display area. For example, the passive vibration member 100 may be a vibration object, a display member, a display panel, a signage panel, a passive vibration plate, a front cover, a front member, a vibration panel, a sound panel, a passive vibration panel, a sound output plate, a sound vibration plate, or a video screen, but embodiments of the present disclosure are not limited thereto.

According to another embodiment of the present disclosure, the passive vibration member 100 may be a vibration plate including a metal material or a nonmetal material (or a complex nonmetal material), which has a material characteristic suitable for outputting a sound based on a vibration of each of the one or more vibration generating apparatuses 200. For example, the passive vibration member 100 may be a vibration plate including one or more materials of metal, plastic, paper, fiber, cloth, wood, leather, rubber, glass, carbon, and mirror. For example, the paper may be a cone paper for speakers. For example, the cone paper may be pulp or foam plastic, but embodiments of the present disclosure are not limited thereto.

The passive vibration member 100 according to another embodiment of the present disclosure may include a display panel including a pixel displaying an image, or may include a non-display panel. For example, the passive vibration member 100 may include one or more of a display panel including a pixel configured to display an image, a screen panel on which an image is to be projected from a display apparatus, a lighting panel, a light emitting diode lighting panel, an organic light emitting lighting panel, an inorganic light emitting lighting panel, a signage panel, a vehicular interior material, a vehicular exterior material, a vehicular glass window, a vehicular seat interior material, a ceiling material of a building, an interior material of a building, a glass window of a building, an interior material of an aircraft, a glass window of an aircraft, and mirror, but embodiments of the present disclosure are not limited thereto. For example, the non-display panel may be a light emitting diode lighting panel (or apparatus), an organic light emitting diode lighting panel (or apparatus), or an inorganic light emitting diode lighting panel (or apparatus), but embodiments of the present disclosure are not limited thereto.

The one or more vibration generating apparatuses 200 may be configured to vibrate the passive vibration member 100. The one or more vibration generating apparatuses 200 may be configured to be connected to a rear surface 100a of the passive vibration member 100 by a connection member 150. Accordingly, the one or more vibration generating apparatuses 200 may vibrate the passive vibration member 100, and thus, may generate or output one or more of a vibration and a sound, based on a vibration of the passive vibration member 100.

The one or more vibration generating apparatuses 200 may include one or more of the vibration apparatuses described above with reference to FIGS. 1 to 13. Accordingly, the descriptions of the vibration apparatuses provided with reference to FIGS. 1 to 13 may be applicable to the vibration apparatuses illustrated with reference to FIGS. 14 and 15, and thus, like reference numerals may refer to like elements and repetitive descriptions thereof may be omitted.

The connection member 150 may be disposed between at least a portion of the vibration generating apparatus 200 and the passive vibration member 100. The connection member 150 may be connected between at least a portion of the vibration generating apparatus 200 and the passive vibration member 100. The connection member 150 according to an embodiment of the present disclosure may be connected between a center portion, except a periphery portion (or an edge portion), of the vibration generating apparatus 200 and the passive vibration member 100. For example, the connection member 150 may be connected between the center portion of the vibration generating apparatus 200 and the passive vibration member 100, based on a partial attachment scheme. The center portion (or a middle portion) of the vibration generating apparatus 200 may be a center of a vibration, and thus, a vibration of the vibration generating apparatus 200 may be efficiently transferred to the passive vibration member 100 through the connection member 150. The periphery portion (or the edge portion) of the vibration generating apparatus 200 may be in a state where the periphery portion (or the edge portion) of the vibration generating apparatus 200 is raised from each of the connection member 150 and the passive vibration member 100 without being connected to the connection member 150 and/or the passive vibration member 100, and thus, when a flexural vibration (or a bending vibration) of the vibration generating apparatus 200 is performed, a vibration of the edge portion of the vibration generating apparatus 200 may not be reduced (prevented) by the connection member 150 and/or the passive vibration member 100, and thus, a vibration width (or a displacement width or a driving width) of the vibration generating apparatus 200 may increase. Accordingly, a vibration width (or a displacement width or a driving width) of the passive vibration member 100 based on a vibration of the vibration generating apparatus 200 may increase, and thus, a sound characteristic and a sound pressure level characteristic of a low-pitched sound band generated based on a vibration of the passive vibration member 100 may be further enhanced.

According to another embodiment of the present disclosure, the connection member 150 may be connected to or attached on or at an entire front surface of the one or more vibration generating apparatuses 200 and the rear surface 100a of the passive vibration member 100, based on a front attachment scheme.

The connection member 150 according to an embodiment of the present disclosure may include a material including an adhesive layer which is good in adhesive force or attaching force with respect to the rear surface 100a of the passive vibration member 100 or the display panel and each of the one or more vibration generating apparatuses 200. For example, the connection member 150 may include a foam pad, a double-sided tape, an adhesive, or the like, but embodiments of the present disclosure are not limited thereto. For example, an adhesive layer of the connection member 150 may include epoxy, acryl, silicone, or urethane, but embodiments of the present disclosure are not limited thereto. For example, the adhesive layer of the connection member 150 may include an acryl-based material, having a characteristic where an adhesive force is relatively good and hardness is high, comparted to a urethane-based material. Accordingly, a vibration of each of the one or more vibration generating apparatuses 200 may be well transferred to the passive vibration member 100.

The apparatus according to an embodiment of the present disclosure may further include a supporting member 300 and a coupling member 350.

The supporting member 300 may be disposed at the rear surface 100a of the passive vibration member 100. The supporting member 300 may be disposed at the rear surface 100a of the passive vibration member 100 to cover the vibration generating apparatus 200. The supporting member 300 may be disposed at the rear surface 100a of the passive vibration member 100 to cover an entire of the rear surface 100a of the passive vibration member 100 and the vibration generating apparatus 200. For example, the supporting member 300 may have a size which is equal to that of the passive vibration member 100. For example, the supporting member 300 may cover the rear surface 100a of the passive vibration member 100 with the vibration generating apparatus 200 and a gap space GS therebetween. For example, the supporting member 300 may cover the entire rear surface 100a of the passive vibration member 100 with the vibration generating apparatus 200 and the gap space GS therebetween. The gap space GS may be provided by the coupling member 350 disposed between the passive vibration member 100 and the supporting member 300 facing each other. The gap space GS may be referred to as an air gap, an accommodating space, a vibration space, and a sounding box, but embodiments of the present disclosure are not limited thereto.

The supporting member 300 may include one or more materials of a glass material, a metal material, and a plastic material. The supporting member 300 may have a stack structure where one or more materials of a glass material, a metal material, and a plastic material are stacked.

Each of the passive vibration member 100 and the supporting member 300 may have a square shape or a rectangular shape, but embodiments of the present disclosure are not limited thereto. For example, each of the passive vibration member 100 and the supporting member 300 may have a polygonal shape, a non-polygonal shape, a circular shape, or an oval shape. For example, in a case where the apparatus according to an example embodiment of the present disclosure is applied to a sound apparatus or a sound bar, each of the passive vibration member 100 and the supporting member 300 may have a rectangular shape where a long-side length is twice or longer than a short-side length, but embodiments of the present disclosure are not limited thereto.

The coupling member 350 may be configured to be connected between a rear edge portion (or a rear periphery portion) of the passive vibration member 100 and a front edge portion (or a front periphery portion) of the supporting member 300, and thus, the gap space GS may be provided between the passive vibration member 100 and the supporting member 300 facing each other.

The coupling member 350 according to an embodiment of the present disclosure may include an elastic material which has adhesive properties and is capable of compression and decompression. For example, the coupling member 350 may include a double-side tape, a single-sided tape, or a double-side adhesive foam pad, but embodiments of the present disclosure are not limited thereto. For example, the coupling member 350 may include an elastic pad such as a rubber pad or a silicone pad, which has adhesive properties and is capable of compression and decompression. For example, the coupling member 350 may be formed by an elastomer.

As another example, the supporting member 300 may further include a sidewall portion which supports the rear edge portion (or the rear periphery portion) of the passive vibration member 100. The sidewall portion of the supporting member 300 may protrude or be bent toward the rear edge portion (or the rear periphery portion) of the passive vibration member 100 from the front edge portion (or the front periphery portion) of the supporting member 300, and thus, the gap space GS may be provided between the passive vibration member 100 and the supporting member 300. In this case, the coupling member 350 may be configured to be connected between the sidewall portion of the supporting member 300 and the rear edge portion (or the rear periphery portion) of the passive vibration member 100. Accordingly, the supporting member 300 may cover the one or more vibration generating apparatuses 200 and may support the rear surface 100a of the passive vibration member 100. For example, the supporting member 300 may cover the one or more vibration generating apparatuses 200 and may support the rear edge portion (or the rear periphery portion) of the passive vibration member 100.

As another example, the passive vibration member 100 may further include a sidewall portion which is connected to the front edge portion (or the front periphery portion) of the supporting member 300. The sidewall portion of the passive vibration member 100 may protrude or be bent toward the front edge portion (or the front periphery portion) of the supporting member 300 from the rear edge portion (or the rear periphery portion) of the passive vibration member 100, and thus, the gap space GS may be provided between the passive vibration member 100 and the supporting member 300. The passive vibration member 100 may increase in stiffness by the sidewall portion thereof. In this case, the coupling member 350 may be configured to be connected between the sidewall portion of the passive vibration member 100 and the rear edge portion (or the rear periphery portion) of the supporting member 300. Accordingly, the supporting member 300 may cover the one or more vibration generating apparatuses 200 and may support the rear surface 100a of the passive vibration member 100. For example, the supporting member 300 may cover the one or more vibration generating apparatuses 200 and may support the rear edge portion (or the rear periphery portion) of the passive vibration member 100.

The apparatus according to an example embodiment of the present disclosure may further include one or more enclosures 250.

The enclosure 250 may be connected or coupled to the rear edge portion (or the rear periphery portion) of the passive vibration member 100 to individually cover the one or more vibration generating apparatuses 200. For example, the enclosure 250 may be connected or coupled to the rear surface 100a of the passive vibration member 100 by a coupling member 251. The enclosure 250 may configure a sealing space, which covers or surrounds the one or more vibration generating apparatuses 200, at the rear surface 100a of the passive vibration member 100. For example, the enclosure 250 may be a sealing member, a sealing cap, a sealing box, or a sound box, but embodiments of the present disclosure are not limited thereto. The sealing space may be an air gap, a vibration space, a sound space, or a sounding box, but embodiments of the present disclosure are not limited thereto.

The enclosure 250 may include one or more materials of a metal material and a nonmetal material (or a complex nonmetal material). For example, the enclosure 250 may include one or more materials of metal, plastic, and wood, but embodiments of the present disclosure are not limited thereto.

The enclosure 250 according to an embodiment of the present disclosure may maintain a constant impedance component based on air acting on the passive vibration member 100 when the passive vibration member 100 or the vibration generating apparatus 200 vibrates. For example, air around the passive vibration member 100 may resist to a vibration of the passive vibration member 100 and may act as an impedance component having a resistance and a reactance component, which vary based on a frequency. Accordingly, the enclosure 250 may configure (or form) a sealing space, which surrounds the one or more vibration generating apparatuses 200, at the rear surface 100a of the passive vibration member 100, and thus, may maintain a constant impedance component (or an air impedance or an elastic impedance) acting on the passive vibration member 100 with air, thereby enhancing a sound characteristic and/or a sound pressure level characteristic of a low-pitched sound band and the sound quality of a high-pitched sound band.

A vibration apparatus according to one or more embodiments of the present disclosure may be applied or included in a vibration apparatus disposed in the device. A apparatus according to an embodiment of the present disclosure includes a mobile device, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theatre apparatuses, theatre display apparatuses, TVs, wall paper display apparatuses, signage apparatuses, game machines, notebook computers, monitors, cameras, camcorders, and home appliances, or the like. Further, the vibration apparatus according to one or more embodiments of the present disclosure may be applied to or included in an organic light-emitting lighting apparatus or an inorganic light-emitting lighting apparatus. When the vibration apparatus is applied to or included in the lighting apparatuses, the lighting apparatuses may act as lighting and a speaker. In addition, when the vibration apparatus according to one or more embodiments of the present disclosure is applied to or included in the mobile apparatuses, or the like, the vibration apparatus may be one or more of a speaker, a receiver, and a haptic device, but embodiments of the present disclosure are not limited thereto.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide non-limiting examples of the technical features of the present disclosure for illustrative purposes. In other words, the disclosed embodiments illustrate the scope of the technical features of the present disclosure and are not intended to be limiting in any respect. Thus, the scope of the present disclosure is not limited to the embodiments shown, but is to be accorded the widest scope consistent with the claims and their equivalents.

What is claimed is:

1. A vibration apparatus, comprising:
a vibration generating part including a plurality of vibration portions;
a connection layer between the plurality of vibration portions; and
a signal cable electrically connected to the plurality of vibration portions,
wherein each of the plurality of vibration portions includes at least one or more connection portions, and
wherein the signal cable is non-overlapping with the at least one or more connection portions.

2. The vibration apparatus of claim 1, wherein:
the vibration generating part includes a first vibration portion and a second vibration portion;
each of the first vibration portion and the second vibration portion comprises:
a first electrode layer;
a second electrode layer; and
a vibration layer between the first electrode layer and the second electrode layer, wherein the vibration layer includes a piezoelectric material; and
the at least one or more connection portions are configured in the vibration layer.

3. The vibration apparatus of claim 2, wherein the at least one or more connection portions comprise a same material as the first electrode layer and the second electrode layer.

4. The vibration apparatus of claim 2, wherein the at least one or more connection portions comprise:
a first connection portion in the vibration layer of the first vibration portion;
a second connection portion in the vibration layer of the second vibration portion and electrically connected to the first connection portion;
a third connection portion in the vibration layer of the first vibration portion and spaced apart from the first connection portion; and
a fourth connection portion in the vibration layer of the second vibration portion and electrically connected to the third connection portion.

5. The vibration apparatus of claim 4, wherein:
the first connection portion and the second connection portion overlap with each other; and
the third connection portion and the fourth connection portion overlap with each other.

6. The vibration apparatus of claim 4, wherein:
the first vibration portion includes a first contact hole at one side of the vibration layer and a third contact hole at another side different from the one side;
the second vibration portion includes a second contact hole on one side of the vibration layer and a fourth contact hole at another side different from the one side where the second contact hole is located;
each of the first to fourth connection portions is inserted into each of the first to fourth contact holes; and
the signal cable is non-overlapping with the first to fourth contact holes.

7. The vibration apparatus of claim 6, wherein:
the signal cable includes first and second signal lines electrically connected to the plurality of vibration portions;
the first signal line is non-overlapping with the third and fourth contact holes; and
the second signal line is non-overlapping with the first and second contact holes.

8. The vibration apparatus of claim 4, wherein:
the first vibration portion includes a first contact hole and a third contact hole spaced apart from each other at one side of the vibration layer;
the second vibration portion includes a second contact hole and a fourth contact hole spaced apart from each other at one side of the vibration layer;
each of the first to fourth connection portions is inserted into each of the first to fourth contact holes; and
the signal cable is non-overlapping with the first to fourth contact holes.

9. The vibration apparatus of claim 8, wherein:
the signal cable includes first and second signal lines electrically connected to the plurality of vibration portions;
the first signal line is non-overlapping with the third and fourth contact holes; and
the second signal line is non-overlapping with the first and second contact holes.

10. The vibration apparatus of claim 4,
wherein the first vibration portion further comprises:
a first auxiliary electrode layer on a first surface of the vibration layer so as to be electrically separated from the first electrode layer; and
a third auxiliary electrode layer on a second surface of the vibration layer so as to be electrically separated from the second electrode layer,
wherein the first auxiliary electrode layer is electrically connected to the second electrode layer of the first vibration portion through the first connection portion, and
wherein the third auxiliary electrode layer is electrically connected to the first electrode layer of the first vibration portion through the third connection portion.

11. The vibration apparatus of claim 4,
wherein the second vibration portion further comprises:
a second auxiliary electrode layer on a first surface of the vibration layer so as to be electrically separated from the first electrode layer; and
a fourth auxiliary electrode layer on a second surface of the vibration layer so as to be electrically separated from the second electrode layer,
wherein the second auxiliary electrode layer is electrically connected to the second electrode layer of the second vibration portion through the second connection portion, and
wherein the fourth auxiliary electrode layer is electrically connected to the first electrode layer of the second vibration portion through the fourth connection portion.

12. The vibration apparatus of claim 2, wherein the connection layer is electrically connected to the second electrode layer between the vibration layer of the first vibration portion and the vibration layer of the second vibration portion.

13. The vibration apparatus of claim 4, further comprising an auxiliary connection layer between the first vibration portion and the second vibration portion so as to be electrically separated from the connection layer.

14. The vibration apparatus of claim 13, wherein:
the first vibration portion further includes a third auxiliary electrode layer on a second surface of the vibration layer so as to be electrically separated from the second electrode layer;
the second vibration portion further includes a fourth auxiliary electrode layer on the second surface of the vibration layer so as to be electrically separated from the second electrode layer; and
the auxiliary connection layer is electrically connected to the third auxiliary electrode and the fourth auxiliary electrode.

15. The vibration apparatus of claim 13, wherein:
the first vibration portion further includes a third auxiliary electrode layer on a second surface of the vibration layer so as to be electrically separated from the second electrode layer;
the second vibration portion further includes a fourth auxiliary electrode layer on the second surface of the vibration layer so as to be electrically separated from the second electrode layer;
the first electrode layer of the second vibration portion is electrically connected to the first electrode layer of the first vibration portion through the fourth connection portion, the fourth auxiliary electrode layer, the auxiliary connection layer, the third auxiliary electrode layer, and the third connection portion; and
the second electrode layer of the second vibration portion is electrically connected to the second electrode layer of the second vibration portion through the connection layer.

16. The vibration apparatus of claim 1, further comprising:
a first cover member connected to a first surface of the vibration generating part; and
a second cover member connected to a second surface of the vibration generating part opposite to the first surface of the vibration generating part.

17. The vibration apparatus of claim 16, wherein:
the signal cable includes first and second signal lines electrically connected to the plurality of vibration portions; and
the first and second signal lines are accommodated between the second surface of the vibration generating part and the second cover member.

18. The vibration apparatus of claim 2, wherein:
the signal cable includes first and second signal lines electrically connected to the plurality of vibration portions;
the first signal line is electrically connected to the first electrode layer of the second vibration portion and the first electrode layer of the first vibration portion; and
the second signal line is electrically connected to the second electrode layer of the first vibration portion, the connection layer, and the second electrode layer of the second vibration portion.

19. An apparatus, comprising:
a passive vibration member; and
a vibration generating apparatus connected to the passive vibration member and vibrating the passive vibration member,
wherein the vibration generating apparatus includes the vibration apparatus of claim 1.

20. The apparatus of claim 19, further comprising an enclosure disposed at a rear of the passive vibration member to cover the vibration generating apparatus.
